(19) United States
(12) Patent Application Publication
(10) Pub. No.: US 2025/0133305 A1
(43) Pub. Date: Apr. 24, 2025

(54) PHOTOELECTRIC CONVERSION DEVICE AND PHOTOELECTRIC CONVERSION SYSTEM

(71) Applicant: CANON KABUSHIKI KAISHA, Tokyo (JP)

(72) Inventors: SEIICHIROU SAKAI, Kanagawa (JP); HIDEO KOBAYASHI, Tokyo (JP); YUSUKE ONUKI, Kanagawa (JP)

(21) Appl. No.: 18/923,216

(22) Filed: Oct. 22, 2024

(30) Foreign Application Priority Data
Oct. 24, 2023 (JP) 2023-182407

(51) Int. Cl. H04N 25/59; H04N 25/77

(52) U.S. Cl. CPC H04N 25/59; H04N 25/77

(57) ABSTRACT

A photoelectric conversion device includes a pixel including a photoelectric conversion unit configured to generate charge by photoelectric conversion, a floating diffusion configured to hold charge transferred from the photoelectric conversion unit, and an output unit configured to output a signal corresponding to an amount of charge held in the floating diffusion, the pixel being enabled to switch a capacitance value of the floating diffusion, and a control unit configured to switch the capacitance value of the floating diffusion. The control unit is configured to set the floating diffusion to a first capacitance value when an absolute value of a power supply voltage supplied to the output unit is a first voltage and set the floating diffusion to a second capacitance value larger than the first capacitance value when the absolute value of the power supply voltage is a second voltage lower than the first voltage.

### BACKGROUND OF THE INVENTION

### Field of the Invention

The present invention relates to a photoelectric conversion device and a photoelectric conversion system.

### Description of the Related Art

Japanese Patent Application Laid-Open No. 2014-033402 describes a solid-state imaging device configured to suppress an increase in power consumption by operating pixels at a voltage lower than a power supply voltage. Japanese Patent Application Laid-Open No. 2010-124418 describes a solid-state imaging device configured to expand a dynamic range by connecting a capacitance addition transistor to a floating diffusion. Japanese Patent Application Laid-Open No. 2020-145699 describes a solid-state imaging device configured to expand a dynamic range by connecting charge-voltage conversion regions of a plurality of pixels and expanding the saturation electron amount of the connected charge-voltage conversion regions as a whole.

However, in the technique described in Japanese Patent Application Laid-Open No. 2014-033402, when the pixel is driven in a power saving mode in which the pixel is operated at a voltage lower than the power supply voltage, the dynamic range of the floating diffusion may decrease. In addition, in the techniques described in Japanese Patent Application Laid-Open No. 2010-124418 and Japanese Patent Application Laid-Open No. 2020-145699, the dynamic range can be secured by increasing the capacitance of the floating diffusion, but when the capacitance of the floating diffusion is increased, the charge-voltage conversion coefficient becomes small, and consequently, the S/N ratio is lowered, and the image quality is deteriorated in some cases.

### SUMMARY OF THE INVENTION

An object of the present invention is to provide a photoelectric conversion device and a photoelectric conversion system capable of easily expanding a dynamic range according to an operation voltage of a pixel and improving an S/N ratio.

According to one aspect of the present specification, there is provided a photoelectric conversion device including a pixel including a photoelectric conversion unit configured to generate charge by photoelectric conversion, a floating diffusion configured to hold charge transferred from the photoelectric conversion unit, and an output unit configured to output a signal corresponding to an amount of charge held in the floating diffusion, the pixel being enabled to switch a capacitance value of the floating diffusion, and a control unit configured to switch the capacitance value of the floating diffusion, wherein the control unit is configured to set the floating diffusion to a first capacitance value when an absolute value of a power supply voltage supplied to the output unit is a first voltage and set the floating diffusion to a second capacitance value larger than the first capacitance value when the absolute value of the power supply voltage is a second voltage lower than the first voltage.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is an equivalent circuit diagram illustrating a configuration example of a pixel of the photoelectric conversion device according to the first embodiment.

FIG. 3A and FIG. 3B are schematic diagrams illustrating a configuration example of the photoelectric conversion device according to the first embodiment.

FIG. 4 is a timing chart illustrating a method of driving the photoelectric conversion device according to the first embodiment.

FIG. 5 is an equivalent circuit diagram illustrating a configuration example of a pixel of a photoelectric conversion device according to a second embodiment.

FIG. 6A, FIG. 6B, FIG. 7A, FIG. 7B, FIG. 8A and FIG. 8B are potential diagrams of a pixel of a photoelectric conversion device according to the second embodiment.

FIG. 9A and FIG. 9B are potential diagrams explaining a method of driving the photoelectric conversion device according to a third embodiment.

FIG. 10 is an equivalent circuit diagram illustrating a configuration example of a pixel of a photoelectric conversion device according to a fourth embodiment.

FIG. 11 and FIG. 12 are timing charts illustrating a method of driving the photoelectric conversion device according to the fourth embodiment.

FIG. 13 is an equivalent circuit diagram illustrating a configuration example of a pixel of a photoelectric conversion device according to a fifth embodiment.

FIG. 14, FIG. 15 and FIG. 16 are timing charts illustrating a method of driving the photoelectric conversion device according to the fifth embodiment.

FIG. 17 is an equivalent circuit diagram illustrating a configuration example of a pixel of a photoelectric conversion device according to a sixth embodiment.

FIG. 18 and FIG. 19 are timing charts illustrating a method of driving the photoelectric conversion device according to the sixth embodiment.

FIG. 20 is an equivalent circuit diagram illustrating a configuration example of a pixel of a photoelectric conversion device according to a seventh embodiment.

FIG. 21 is a diagram illustrating an interconnection capacitance in the pixel configuration of the sixth embodiment.

FIG. 22 is a diagram illustrating an interconnection capacitance in the pixel configuration according to the seventh embodiment.

FIG. 23, FIG. 24 and FIG. 25 are timing charts illustrating a method of driving the photoelectric conversion device according to the seventh embodiment.

FIG. 26 is a block diagram illustrating a schematic configuration of a photoelectric conversion system according to an eighth embodiment.

FIG. 27A is a diagram illustrating a configuration example of a photoelectric conversion system according to a ninth embodiment.

FIG. 27B is a diagram illustrating a configuration example of a movable object according to the ninth embodiment.

FIG. 28 is a block diagram illustrating a schematic configuration of an equipment according to a tenth embodiment.

### DESCRIPTION OF THE EMBODIMENTS

Preferred embodiments of the present invention will now be described in detail in accordance with the accompanying drawings.

### First Embodiment

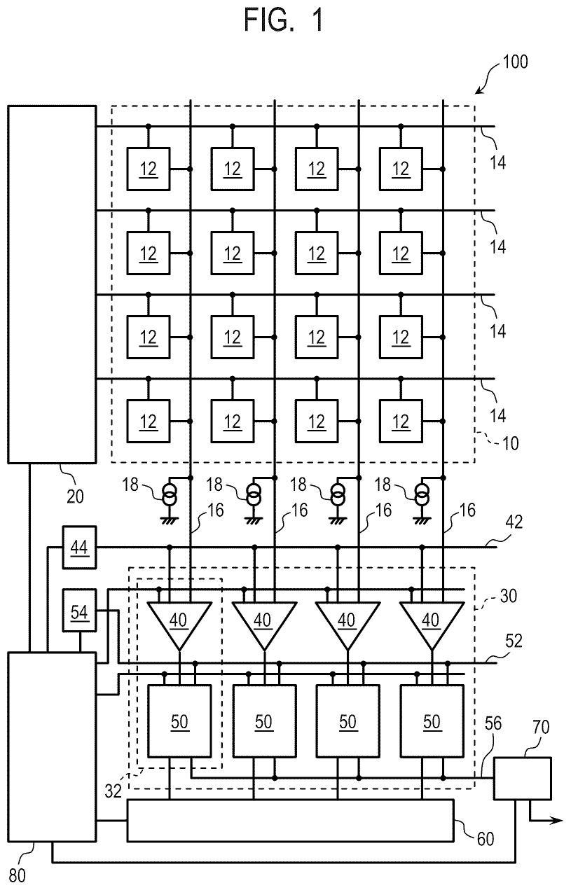

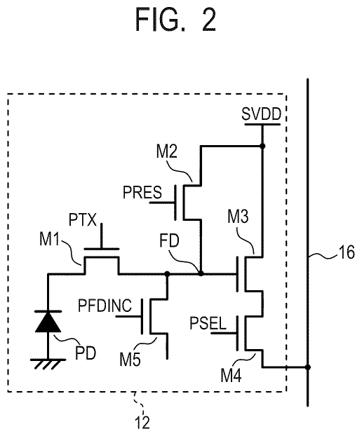

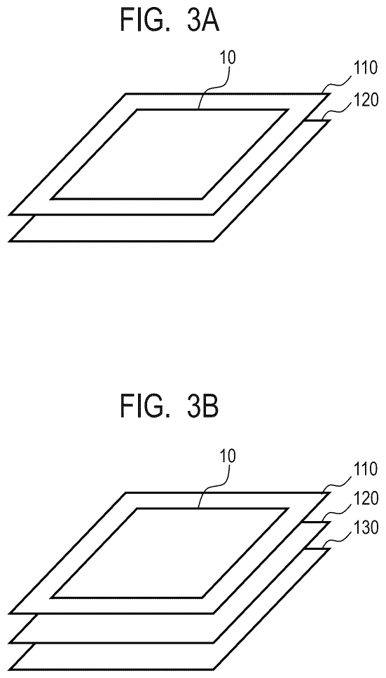

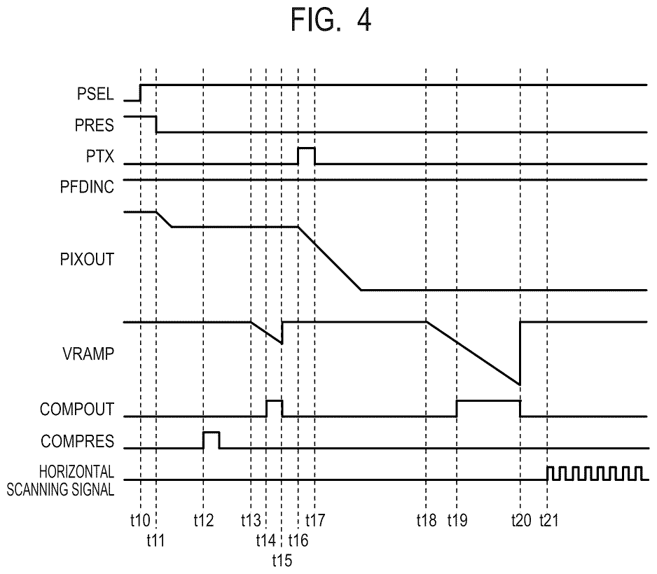

A photoelectric conversion device and a method of driving the same according to a first embodiment of the present invention will be described with reference to FIG. 1 to FIG. 4. FIG. 1 is a block diagram illustrating a schematic configuration of a photoelectric conversion device according to the present embodiment. FIG. 2 is an equivalent circuit diagram illustrating a configuration example of a pixel in the photoelectric conversion device according to the present embodiment. FIG. 3A and FIG. 3B are schematic diagrams illustrating a configuration example of the photoelectric conversion device according to the present embodiment. FIG. 4 is a timing chart illustrating a method of driving the photoelectric conversion device according to the present embodiment.

First, a schematic configuration of a photoelectric conversion device according to the present embodiment will be described with reference to FIG. 1. As illustrated in FIG. 1, the photoelectric conversion device 100 according to the present embodiment includes a pixel array unit 10, a vertical scanning circuit 20, a readout circuit 30, a reference signal output circuit 44, a counter circuit 54, a horizontal scanning circuit 60, a signal processing circuit 70, and a timing generation unit 80.

The pixel array unit 10 is provided with a plurality of pixels 12 arranged in a matrix over a plurality of rows and a plurality of columns. Each pixel 12 includes a photoelectric conversion unit including a photoelectric conversion element such as a photodiode, and outputs a pixel signal according to an amount of incident light. Although FIG. 1 illustrates a total of 16 pixels 12 arranged in four rows and four columns, typically, tens of millions of pixels 12 are arranged in the pixel array unit 10. The number of rows and the number of columns of the pixel array arranged in the pixel array unit 10 are not particularly limited. In addition to effective pixels that output pixel signals according to the amount of incident light, the pixel array unit 10 may include optical black pixels in which photoelectric conversion units are shielded from light, dummy pixels that do not output signals, and the like.

In each row of the pixel array unit 10, a control line 14 is arranged so as to extend in a first direction (lateral direction in FIG. 1). Each of the control lines 14 is connected to the pixels 12 arranged in the first direction on the corresponding row and forms a signal line common to these pixels 12. The first direction in which the control lines 14 extend may be referred to as a row direction or a horizontal direction. The control lines 14 are connected to the vertical scanning circuit 20. The control line 14 in each row may include a plurality of signal lines.

In each column of the pixel array unit 10, a vertical output line 16 is arranged so as to extend in a second direction (vertical direction in FIG. 1) intersecting the first direction. Each of the vertical output lines 16 is connected to the pixels 12 arranged in the second direction on the corresponding column and forms a signal line common to these pixels 12. The second direction in which the vertical output lines 16 extend may be referred to as a column direction or a vertical direction. The vertical output lines 16 are connected to the readout circuit 30. A current source 18 is connected to the vertical output line 16 of each column. A plurality of vertical output lines 16 may be arranged in each column of the pixel array unit 10.

The vertical scanning circuit 20 has a function of generating control signals for driving the pixels 12 in response to control signals from the timing generation unit 80 and outputting the generated control signals to the pixels 12 via the control lines 14. A logic circuit such as a shift register, or an address decoder may be used as the vertical scanning circuit 20. The vertical scanning circuit 20 sequentially outputs the control signals to the control lines 14 of each row, and sequentially drives the pixels 12 of the pixel array unit 10 in units of rows. The signals read out from the pixels 12 in units of rows are input to the readout circuit 30 via the vertical output lines 16 arranged in each column of the pixel array unit 10.

The readout circuit 30 includes a plurality of column circuits 32 corresponding to the number of vertical output lines 16. The column circuit 32 has a function of performing analog-to-digital conversion (AD conversion) on the output signal of the pixel 12. Each of the column circuits 32 includes a comparator 40 and a memory 50. The comparator 40 has two input nodes and one output node. The memory 50 has three input nodes and one output node. A first input node of the comparator 40 is connected to the corresponding vertical output line 16. A second input node of the comparator 40 is connected to the reference signal output circuit 44 via a reference signal line 42. An output node of the comparator 40 is connected to a first input node of the memory 50. A second input node of the memory 50 is connected to the counter circuit 54 via a count signal line 52. A third input node of the memory 50 is connected to the horizontal scanning circuit 60. An output node of the memory 50 is connected to the signal processing circuit 70 via a horizontal output line 56.

The reference signal output circuit 44 has a function of generating a reference signal to be used for the AD conversion and outputting the generated reference signal to the comparator 40 of each column via the reference signal line 42. The reference signal used for the AD conversion may be a signal having a predetermined amplitude according to a range of the pixel signal and having a signal level that changes with time. Although the reference signal is not particularly limited, for example, a ramp signal in which the signal level monotonically increases or monotonically decreases with time may be applied. Note that the change in the signal level does not necessarily have to be continuous and may be stepwise. In addition, the change in the signal level does not necessarily need to be linear with respect to time and may be curved with respect to time (for example, a sine wave or a cosine wave).

The counter circuit 54 has a function of counting a clock pulse signal CLK supplied from a clock pulse supply unit (not illustrated) in accordance with a control signal from the timing generation unit 80 and outputting a count signal CNT indicating a count value to the memory 50 of each column. The counter circuit 54 starts a counting operation in synchronization with a timing at which a change in the signal level of the reference signal output from the reference signal output circuit 44 starts.

The horizontal scanning circuit 60 has a function of generating control signals for reading out the pixel signals from the column circuits 32 of the readout circuit 30 in response to control signals from the timing generation unit 80 and outputting the generated control signals to the readout circuit 30. The horizontal scanning circuit 60 sequentially scans the column circuits 32 of the respective columns of the readout circuit 30, and sequentially outputs the pixel signals held in the respective memories 50 to the signal processing circuit 70 via the horizontal output line 56. A logic circuit such as a shift register or an address decoder may be used as the horizontal scanning circuit 60.

The signal processing circuit 70 is a processing circuit that performs predetermined signal processing on the pixel signal of the column selected by the horizontal scanning circuit 60 and outputs the processed pixel data, and includes a buffer amplifier, a differential amplifier, and the like. The external interface circuit included in the signal processing circuit 70 is not particularly limited. As the external interface circuit, for example, a serializer/deserializer (SerDes) transmission circuit may be applied. The SerDes transmission circuit is, for example, a low voltage differential signaling (LVDS) circuit or a scalable low voltage signaling (SLVS) circuit.

The timing generation unit 80 is a control circuit that generates control signals for controlling the operations and timings of the vertical scanning circuit 20, the comparators 40, the reference signal output circuit 44, the memories 50, the counter circuit 54, the horizontal scanning circuit 60, and the signal processing circuit 70, and supplies the generated control signals to the corresponding functional blocks. At least a part of the control signals supplied to these functional blocks may be supplied from the outside of the photoelectric conversion device 100.

As illustrated in, e.g., FIG. 2, each of the pixels 12 included in the pixel array unit 10 may include a photoelectric conversion element PD, a transfer transistor M1, a reset transistor M2, an amplifier transistor M3, a select transistor M4, and a capacitance addition transistor M5.

The photoelectric conversion element PD may be, for example, a photodiode. The photoelectric conversion element PD has an anode connected to the ground voltage node and a cathode connected to a source of the transfer transistor M1. A drain of the transfer transistor M1 is connected to a source of the reset transistor M2, a gate of the amplifier transistor M3, and a drain of the capacitance addition transistor M5. A node FD to which the drain of the transfer transistor M1, the source of the reset transistor M2, the gate of the amplifier transistor M3, and the drain of the capacitance addition transistor M5 are connected is a so-called floating diffusion. The floating diffusion includes a capacitance component (floating diffusion capacitance) and has a function as a charge holding portion. The floating diffusion capacitance may include a gate capacitance of the transistor, a p-n junction capacitance, an interconnection capacitance, and the like. A source of the capacitance addition transistor M5 is connected to a floating node. Note that “connected to a floating node” means that the source of the capacitance addition transistor M5 is in an electrically floating state, and the source of the capacitance addition transistor M5 does not necessarily need to be electrically connected to another member. A drain of the reset transistor M2 and a drain of the amplifier transistor M3 are connected to a node to which the power supply voltage (voltage SVDD) is supplied. A source of the amplifier transistor M3 is connected to a drain of the select transistor M4. A source of the select transistor M4 is connected to the vertical output line 16.

In the case of the pixel configuration of FIG. 2, the control line 14 of each row includes four signal lines including a signal line connected to a gate of the transfer transistor M1, a signal line connected to a gate of the reset transistor M2, a signal line connected to a gate of the select transistor M4, and a signal line connected to a gate of the capacitance addition transistor M5. The control signal PTX is supplied from the vertical scanning circuit 20 to the gate of the transfer transistor M1. The control signal PRES is supplied from the vertical scanning circuit 20 to the gate of the reset transistor M2. The control signal PSEL is supplied from the vertical scanning circuit 20 to the gate of the select transistor M4. The control signal PFDINC is supplied from the vertical scanning circuit 20 to the gate of the capacitance addition transistor M5. When each transistor is formed of an n-channel MOS transistor, the corresponding transistor is turned on when a high-level control signal is supplied from the vertical scanning circuit 20. When a low-level control signal is supplied from the vertical scanning circuit 20, the corresponding transistor is turned off.

The present embodiment will be described on the assumption that electrons among electron-hole pairs generated in the photoelectric conversion element PD by light incidence are used as a signal charge. When electrons are used as the signal charge, each transistor constituting the pixel 12 may be configured by an n-channel MOS transistor disposed in the p-well. However, the signal charge is not limited to electrons, and holes may be used as the signal charge. When holes are used as the signal charge, the conductivity type of each transistor may be opposite to that described in the present embodiment. The names of the source and the drain of the MOS transistor may vary depending on the conductivity type of the transistor or the function of interest. Some or all of the names of the source and the drain used in the present embodiment may be referred to as reverse names.

The photoelectric conversion element PD converts (photoelectrically converts) the incident light into electric charge of an amount corresponding to the amount of the incident light and accumulates the generated charge. The transfer transistor M1 transfers the charge held in the photoelectric conversion element PD to the node FD by turning on. The charge transferred from the photoelectric conversion element PD is held by the capacitance component (floating diffusion capacitance) of the node FD. As a result, the node FD has a potential corresponding to the amount of charge transferred from the photoelectric conversion element PD by charge-voltage conversion by the floating diffusion capacitance.

The capacitance addition transistor M5 has a function of switching the capacitance value of the floating diffusion. That is, since the channel capacitance is added to the capacitance of the node FD when the capacitance addition transistor M5 is turned on, the capacitance value of the floating diffusion when the capacitance addition transistor M5 is turned on is larger than the capacitance value of the floating diffusion when the capacitance addition transistor M5 is turned off. As described above, the pixel 12 of the present embodiment is configured to be capable of switching the capacitance value of the floating diffusion by the capacitance addition transistor M5. The capacitance addition transistor M5 is controlled by the control signal PFDINC from the vertical scanning circuit 20. That is, it can be said that the vertical scanning circuit 20 is a control unit that switches the capacitance value of the floating diffusion.

The reset transistor M2 has a function of controlling a reset operation for resetting the node FD as a charge holding portion. That is, the reset transistor M2 is a reset unit that resets the node FD to a voltage corresponding to the voltage SVDD by turning on.

The select transistor M4 connects the amplifier transistor M3 to the vertical output line 16 by turning on. The amplifier transistor M3 is configured to have the drain to which the voltage SVDD is supplied and the source to which the bias current is supplied from the current source 18 via the select transistor M4, and constitutes an amplification unit (source follower circuit) having the gate as an input node. Accordingly, the amplifier transistor M3 outputs a signal based on the potential of the node FD to the vertical output line 16 via the select transistor M4. In this sense, the amplifier transistor M3 and the select transistor M4 forms an output unit that outputs a pixel signal according to the amount of charge held in the node FD.

A pixel signal (hereinafter, referred to as a pixel output signal PIXOUT) output from the pixel 12 via the vertical output line 16 is input to the first input node of the comparator 40. A reference signal VRAMP output from the reference signal output circuit 44 is input to the second input node of the comparator via the reference signal line 42.

The comparator 40 compares the level of the pixel output signal PIXOUT with the level of the reference signal VRAMP, and outputs a signal corresponding to the magnitude relationship therebetween. For example, the comparator 40 outputs a high-level signal COMPOUT when the level of the reference signal VRAMP is lower than the level of the pixel output voltage PIXOUT. When the level of the reference signal VRAMP is higher than the level of the pixel output voltage PIXOUT, the comparator 40 outputs a low-level signal COMPOUT. The relationship between the magnitude of the input signal and the level of the output signal may be reversed.

The counter circuit 54 starts the counting operation of the clock pulse signal CLK when the reference signal VRAMP output from the reference signal output circuit 44 starts to change depending on time, and outputs a count signal CNT indicating the count value. That is, the counter circuit 54 counts the clock pulse signal CLK in parallel with the change in the potential of the reference signal VRAMP and generates and outputs the count signal CNT.

A signal COMPOUT output from the comparator 40 is input to a first input node of the memory 50. The count signal CNT output from the counter circuit 54 is input to the second input node of the memory 50 via the count signal line 52. The memory 50 holds the count value indicated by the count signal CNT output from the counter circuit 54 at the timing when the level of the signal COMPOUT output from the comparator 40 is inverted, as a digital signal of the pixel output signal PIXOUT. The memory 50 may hold a digital signal obtained by performing the AD conversion on a reset level signal (hereinafter, referred to as an N-signal) and a digital signal obtained by performing the AD conversion on a signal obtained by superimposing the signal of the photoelectric conversion element PD on the N-signal in the node FD (hereinafter, referred to as an S-signal).

The digital signals held in the memories 50 are sequentially transferred to the signal processing circuit 70 via the horizontal output line 56 for each column in accordance with the control signal supplied from the horizontal scanning circuit 60. The signal processing circuit 70 performs a correction process of removing a noise component by subtracting the N-signal from the S-signal, and outputs the processed signal to the outside of the photoelectric conversion device 100.

The photoelectric conversion device 100 according to the present embodiment may have a configuration in which all the functional blocks described above are disposed on one substrate or may have a configuration as a stacked-type photoelectric conversion device in which the functional blocks described above are separately formed on a plurality of substrates and these substrates are bonded and electrically connected.

FIG. 3A is a schematic view of a case where the pixel substrate 110 and the circuit substrate 120 are stacked. For example, the pixel array unit 10 may be disposed on the pixel substrate 110. For example, the vertical scanning circuit 20, the readout circuit 30, the reference signal output circuit 44, the counter circuit 54, the horizontal scanning circuit 60, the signal processing circuit 70, and the timing generation unit 80 may be disposed on the circuit substrate 120. By arranging the pixel substrate 110 and the circuit substrate 120 on different substrates, it is possible to reduce the size of the photoelectric conversion device 100 without sacrificing the area of the pixel array unit 10.

FIG. 3B is a schematic view of a case where the pixel substrate 110 and the circuit substrates 120 and 130 are stacked. For example, the pixel array unit 10 may be disposed on the pixel substrate 110. For example, the vertical scanning circuit 20, the readout circuit 30, the reference signal output circuit 44, the counter circuit 54, the horizontal scanning circuit 60, the signal processing circuit 70, and the timing generation unit 80 may be disposed on the circuit substrates 120 and 130. Also in this case, it is possible to reduce the size of the photoelectric conversion device 100 without sacrificing the area of the pixel array unit 10.

The circuit elements constituting one functional block are not necessarily arranged on the same substrate and may be arranged on different substrates.

Next, a method of driving the photoelectric conversion device according to the present embodiment will be described more specifically with reference to FIG. 4. The photoelectric conversion device 100 according to the present embodiment may include two modes, i.e., a power saving mode and a normal mode, as operation modes. Here, the power saving mode is a mode in which the signal of the pixel 12 is read out by lowering the voltage level of the voltage SVDD as compared with the normal mode. The voltage level of the voltage SVDD may be changed by switching the value of the power supply voltage input to the photoelectric conversion device 100 by an external system or may be changed by a transformer circuit included in the photoelectric conversion device 100.

FIG. 4 is a timing chart illustrating an example of a pixel signal readout operation in the power saving mode. FIG. 4 illustrates waveforms of the control signals PSEL, PRES, PTX, PFDINC, the pixel output signal PIXOUT, the reference signal VRAMP, the signal COMPOUT, the signal COMPRES, and the horizontal scanning signal of the row to which the pixel 12 to be read out belongs. The signal COMPRES is a control signal for controlling the reset operation of the comparator 40. The horizontal scanning signal is a control signal supplied from the horizontal scanning circuit 60 to the memory 50 of each column.

It is assumed that, in a period just before time t10, the control signals PSEL and PTX are at low-level, and the control signals PRES and PFDINC are at high-level. As a result, the capacitance addition transistor M5 is turned on, and the capacitance (capacitance value Cinc1) generated by the channel of the capacitance addition transistor M5 is added to the capacitance of the node FD. The reset transistor M2 is turned on, and the node FD is reset to a voltage corresponding to the voltage SVDD. The reference signal VRAMP has a predetermined initial voltage. When the photoelectric conversion device operates in the normal mode, the control signal PFDINC may be set to low-level to keep the capacitance addition transistor M5 in off.

At the time t10, the vertical scanning circuit 20 controls the control signal PSEL from low-level to high-level. As a result, the select transistors M4 of the pixels 12 in the row to which the pixels 12 to be read out belongs are turned on. That is, the row is selected. As a result, a signal (pixel output signal PIXOUT) of a level corresponding to the reset voltage of the node FD is output to the vertical output lines 16 via the select transistors M4.

At the subsequent time t11, the vertical scanning circuit 20 controls the control signal PRES from high-level to low-level. As a result, the reset transistor M2 is turned off, and the reset state of the node FD is canceled. When the control signal PRES changes from high-level to low-level, the voltage of the node FD decreases due to capacitive coupling between the gate and the source of the reset transistor M2, and the level of the pixel output signal PIXOUT also decreases accordingly. Here, the pixel output signal PIXOUT after the signal level is settled is referred to as a pixel reset level signal. The pixel reset level signal is a signal including a noise component of the pixel 12.

During a predetermined period from time t12 after the potential of the vertical output line 16 is settled, the timing generation unit 80 controls the control signal COMPRES to high-level. As a result, the reset operation of the comparator 40 is performed, and the comparator 40 is initialized.

At time t13 after the control signal COMPRES transitions to low-level, the reference signal output circuit 44 starts a slope operation of gradually decreasing the voltage of the reference signal VRAMP with time. The counter circuit 54 starts counting up in synchronization with the start of the slope operation, and outputs a count signal CNT indicating the count value to the memory 50 of each column via the count signal line 52.

The comparator 40 of each column performs a comparison operation between the signal level of the pixel output signal PIXOUT and the signal level of the reference signal VRAMP, and outputs a signal COMPOUT corresponding to the result of the comparison. That is, the signal level of the signal COMPOUT is inverted at the timing when the magnitude relationship between the signal level of the pixel output voltage PIXOUT and the signal level of the reference signal VRAMP changes. For example, as illustrated in FIG. 4, when the signal level of the reference signal VRAMP becomes lower than the signal level of the pixel output signal PIXOUT at time t14, the signal level of the signal COMPOUT transitions from low-level to high-level at this timing. The memory 50 holds the count value indicated by the count signal CNT at the timing when the signal level of the signal COMPOUT changes as digital data of the pixel reset level (a value obtained by performing the AD conversion on the N-signal).

At the subsequent time t15, the reference signal output circuit 44 stops changing the signal level of the reference signal VRAMP and resets the reference signal VRAMP to the initial voltage. The counter circuit 54 stops counting the clock pulses and returns the count value to the initial value. The signal level of the signal COMPOUT output from the comparator 40 returns to low-level along with the initialization of the reference signal VRAMP.

In the subsequent period from time t16 to time t17, the vertical scanning circuit 20 controls the control signal PTX to high-level. As a result, the transfer transistor M1 is turned on, and the charge accumulated in the photoelectric conversion element PD during a predetermined exposure period is transferred to the node FD. The voltage of the node FD decreases in accordance with the amount of charge transferred from the photoelectric conversion element PD. The amplifier transistor M3 outputs the pixel output signal PIXOUT corresponding to the potential of the node FD to which the charge generated in the photoelectric conversion element PD is transferred to the vertical output line 16 via the select transistor M4. The pixel output signal PIXOUT at this time is a pixel signal of the light signal level of the pixel 12.

At time t18 after the potential of the vertical output line 16 is settled, the reference signal output circuit 44 starts again the slope operation of gradually decreasing the voltage of the reference signal VRAMP with time. The counter circuit 54 starts counting up in synchronization with the start of the slope operation, and outputs a count signal CNT indicating the count value to the memory 50 of each column via the count signal line 52.

The comparator 40 of each column performs a comparison operation between the signal level of the pixel output signal PIXOUT and the signal level of the reference signal VRAMP, and outputs a signal COMPOUT corresponding to the result of the comparison. For example, as illustrated in FIG. 4, when the signal level of the reference signal VRAMP becomes lower than the signal level of the pixel output signal PIXOUT at time t19, the signal level of the signal COMPOUT transitions from low-level to high-level at this timing. The memory 50 holds the count value indicated by the count signal CNT at the timing when the signal level of the signal COMPOUT changes as digital data of the light signal level (a value obtained by performing the AD conversion on the S-signal).

At the subsequent time t20, the reference signal output circuit 44 stops changing the signal level of the reference signal VRAMP and resets the reference signal VRAMP to the initial voltage. The counter circuit 54 stops counting the clock pulses and returns the count value to the initial value. The signal level of the signal COMPOUT output from the comparator 40 returns to low-level along with the initialization of the reference signal VRAMP.

At the subsequent time t21, the timing generation unit 80 starts the horizontal transfer operation of the digital data from the readout circuit 30 to the signal processing circuit 70. The horizontal scanning circuit 60 sequentially outputs horizontal scanning signals to the memory 50 of each column under the control of the timing generation unit 80. The memory 50 that has received the horizontal scanning signal from the horizontal scanning circuit 60 transfers the digital data of the N-signal and the digital data of the S-signal to the signal processing circuit 70 via the horizontal output line 56. The signal processing circuit 70 calculates a differential signal level (light component) obtained by subtracting the N-signal from the S-signal, and outputs the differential signal level to the outside of the photoelectric conversion device 100.

In the power saving mode, as described above, the voltage level of the voltage SVDD is lowered than that in the normal mode, and the readout operation of the pixel signal is performed. However, when the voltage SVDD is lowered, the range of the usable signal voltage becomes narrow, and thus the dynamic range on the floating diffusion (node FD) or the vertical output line 16 is lowered.

In this regard, in the present embodiment, the capacitance value of the floating diffusion is increased by turning on the capacitance addition transistor M5 in the power saving mode. For example, in a case that the capacitance value Cfd of the node FD when the capacitance addition transistor M5 is turned off and the capacitance value Cinc1 of the capacitance generated by turning on the capacitance addition transistor M5 are the same, the capacitance value of the node FD is doubled by turning on the capacitance addition transistor M5. Since the potential of the node FD is proportional to the amount of the signal charge and the reciprocal of the capacitance value of the floating diffusion, if the capacitance value of the floating diffusion is doubled, the signal amplitude of the signal generated by the signal charge from the photoelectric conversion element PD at the node FD becomes half. Further, since the amplifier transistor M3 outputs a signal based on the potential of the node FD to the vertical output line 16, if the signal amplitude generated on the node FD becomes half, the signal amplitude generated on the vertical output line 16 also becomes half.

As described above, in the power saving mode, the voltage SVDD is lowered and the capacitance addition transistor M5 is turned on to increase the capacitance value of the floating diffusion. Thus, the dynamic range is secured by narrowing the signal amplitude on the node FD and the vertical output line 16, and all the signal charge held by the photoelectric conversion element PD may be read out. In addition, since the power consumption may be reduced by lowering the voltage level of the voltage SVDD, deterioration in image quality due to heat generation may be reduced, and the number of still images to be shot and the continuous shooting time of moving images may be increased when the battery capacity is limited.

As described above, according to the present embodiment, it is possible to realize the photoelectric conversion device capable of easily expanding the dynamic range according to the operation voltage of the pixel and improving the S/N ratio.

### Second Embodiment

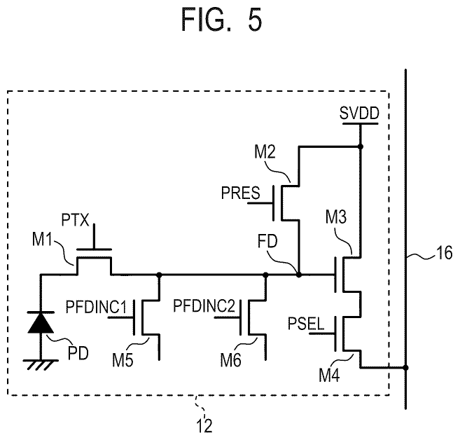

A photoelectric conversion device and a method of driving the same according to a second embodiment of the present invention will be described with reference to FIG. 5. The same components as those of the photoelectric conversion device according to the first embodiment are denoted by the same reference numerals, and description thereof will be omitted or simplified. FIG. 5 is an equivalent circuit diagram illustrating a configuration example of a pixel in the photoelectric conversion device according to the present embodiment.

The photoelectric conversion device according to the present embodiment is the same as the photoelectric conversion device according to the first embodiment except that the configuration of the pixel 12 is different. In the present embodiment, differences from the photoelectric conversion device according to the first embodiment will be mainly described, and description of points similar to those of the photoelectric conversion device according to the first embodiment will be appropriately omitted.

As illustrated in FIG. 5, the pixel 12 of the photoelectric conversion device according to the present embodiment further includes a capacitance addition transistor M6 in addition to the transfer transistor M1, the reset transistor M2, the amplifier transistor M3, and the capacitance addition transistor M5. A drain of the capacitance addition transistor M6 is connected to the node FD. The source of the capacitance addition transistor M6 is connected to a floating node. That is, the capacitance addition transistors M5 and M6 are connected in parallel between the node FD and the floating node. A control signal PFDINC1 is input to the gate of the capacitance addition transistor M5 from the vertical scanning circuit 20 via the control line 14, and a control signal PFDINC2 is input to a gate of the capacitance addition transistor M6 from the vertical scanning circuit 20 via the control line 14.

Like the capacitance addition transistor M5, the capacitance addition transistor M6 has a function of switching the capacitance value of the floating diffusion. That is, since the channel capacitance is added to the capacitance of the node FD when the capacitance addition transistor M6 is turned on, the capacitance value of the floating diffusion when the capacitance addition transistor M6 is turned on is larger than the capacitance value of the floating diffusion when the capacitance addition transistor M6 is turned off. The capacitance addition transistor M5 and the capacitance addition transistor M6 may be independently controlled.

Here, the capacitance value of the node FD when the capacitance addition transistors M5 and M6 are off is Cfd. Further, a capacitance value of the capacitance generated when the capacitance addition transistor M5 is turned on is denoted by Cinc1, and a capacitance value of the capacitance generated when the capacitance addition transistor M6 is turned on is denoted by Cinc2. When the capacitance value Cfd, the capacitance value Cinc1, and the capacitance value Cinc2 are the same, the floating diffusion capacitance can take three types of capacitance values according to the drive states of the capacitance addition transistors M5 and M6.

In this case, the capacitance value of the floating diffusion when only one of the capacitance addition transistors M5 and M6 is turned on is twice the capacitance value Cfd of the floating diffusion when the capacitance addition transistors M5 and M6 are turned off, and the signal amplitude generated on the node FD is ½. The capacitance value of the floating diffusion when both of the capacitance addition transistors M5 and M6 are turned on is three times the capacitance value Cfd of the floating diffusion when the capacitance addition transistors M5 and M6 are turned off, and the signal amplitude generated on the node FD is ⅓.

Therefore, according to the present configuration, it is possible to set two types of power saving modes having lower power consumption than the normal mode. That is, in the power saving mode 1 in which the voltage SVDD is lowered and only one of the capacitance addition transistors M5 and M6 is turned on, the signal amplitude on the node FD and the vertical output line 16 may be narrowed to one half. In addition, in the power saving mode 2 in which the voltage SVDD is further lowered and both of the capacitance addition transistors M5 and M6 are turned on, the signal amplitude on the node FD and the vertical output line 16 may be narrowed to one third. As a result, power consumption may be reduced, deterioration in image quality due to heat generation may be reduced, and the number of still images to be shot and the continuous shooting time of moving images may be increased when the battery capacity is limited.

As described above, according to the present embodiment, it is possible to realize the photoelectric conversion device capable of easily expanding the dynamic range according to the operation voltage of the pixel and improving the S/N ratio.

### Third Embodiment

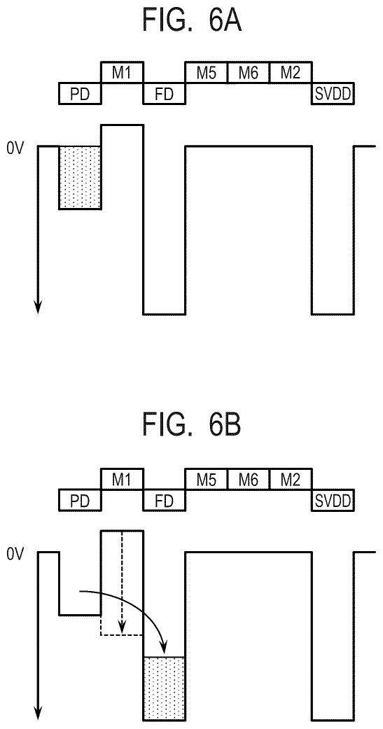

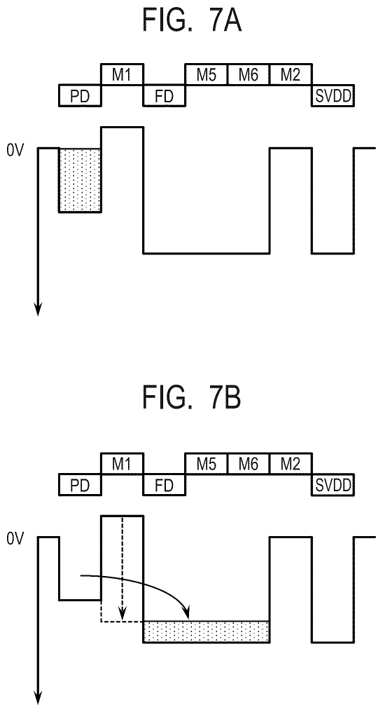

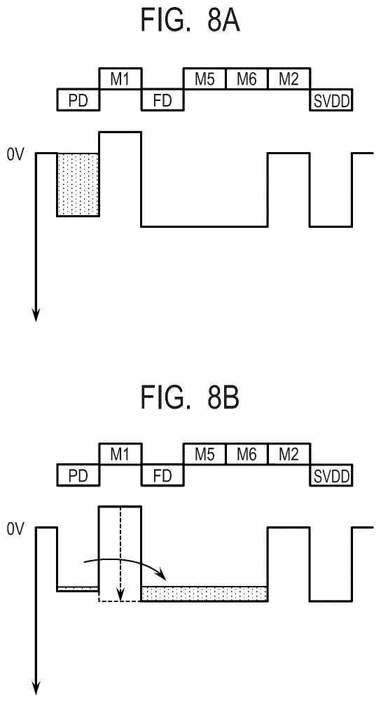

A photoelectric conversion device and a method of driving the same according to a third embodiment of the present invention will be described with reference to FIG. 6A to FIG. 9B. The same components as those of the photoelectric conversion device according to the first or second embodiment are denoted by the same reference numerals, and description thereof will be omitted or simplified. FIG. 6A to FIG. 9B are potential diagrams of a pixel of the photoelectric conversion device according to the second embodiment.

In the second embodiment, the capacitance value of the floating diffusion is increased by the capacitance addition transistors M5 and M6 to narrow the signal amplitude on the FD and the vertical output line 16, thereby securing the dynamic range and reading out all the signal charges of the photoelectric conversion element PD. However, if the voltage SVDD is too low, it may happen that all the signal charge accumulated in the photoelectric conversion element PD cannot be read out. In the present embodiment, a configuration example of a photoelectric conversion device capable of achieving both reduction in power consumption and complete transfer of the signal charge from the photoelectric conversion element PD to the node FD will be described.

Before describing a specific content of the present embodiment, a mechanism in which all the signal charge in the photoelectric conversion element PD cannot be read out by lowering the voltage level of the voltage SVDD will be described with reference to FIG. 6A to FIG. 8B.

FIG. 6A and FIG. 6B illustrate potentials in a state where the capacitance addition transistors M5 and M6 are turned off to reduce the capacitance value of the floating diffusion in the pixel of the second embodiment. In the figure, PD indicates the potential of the photoelectric conversion element PD, M1 indicates the potential below the gate of the transfer transistor M1, and FD indicates the potential of the node FD. M5 indicates the potential below the gate of the capacitance addition transistor M5, M6 indicates the potential below the gate of the capacitance addition transistor M6, and M2 indicates the potential below the gate of the reset transistor M2. SVDD indicates the potential of the voltage SVDD supplied to the drain of the reset transistor M2. In the figure, the downward direction is the direction of the positive potential.

FIG. 6A illustrates the potential at the time of accumulating the signal charge in the photoelectric conversion element PD. In the exposure period of the photoelectric conversion element PD, the transfer transistor M1 is turned off, and the signal charge is accumulated in the photoelectric conversion element PD.

FIG. 6B illustrates the potential after transferring the signal charge from the photoelectric conversion element PD to the node FD. When the transfer transistor M1 is turned on, the potential barrier between the photoelectric conversion element PD and the node FD decreases to a position indicated by a broken line. Thus, the signal charge accumulated in the photoelectric conversion element PD is transferred to the node FD. At this time, although the capacitance addition transistors M5 and M6 are off and the capacitance value of the floating diffusion is small, all the signal charge accumulated in the photoelectric conversion element PD may be transferred to the node FD by increasing the voltage level of the voltage SVDD.

FIG. 7A and FIG. 7B illustrate the potentials in a state where the voltage level of the voltage SVDD is lowered and the capacitance addition transistors M5 and M6 are both turned on to increase the capacitance value of the floating diffusion in the pixel of the second embodiment. The signs and the directions of the potentials described in the drawings are the same as those in FIG. 6A and FIG. 6B.

FIG. 7A illustrates the potential at the time of accumulating the signal charge in the photoelectric conversion element PD. In the exposure period of the photoelectric conversion element PD, the transfer transistor M1 is turned off, and the signal charge is accumulated in the photoelectric conversion element PD. The capacitance addition transistors M5 and M6 are both turned on, and the capacitance value of the floating diffusion is (Cfd+Cinc1+Cinc2). Further, the signal level of the voltage SVDD is lower than that in the case of FIG. 6A and FIG. 6B, and the potential of the node FD is also lower than that in the case of FIG. 6A and FIG. 6B.

FIG. 7B illustrates the potential after transferring the signal charge from the photoelectric conversion element PD to the node FD. When the transfer transistor M1 is turned on, the potential barrier between the photoelectric conversion element PD and the node FD decreases to a position indicated by a broken line. Thus, the signal charge accumulated in the photoelectric conversion element PD is transferred to the node FD. If it is assumed that the capacitance values Cfd, Cinc1, and Cinc2 are the same, that is, the capacitance value of the floating diffusion is three times that in the case of FIG. 6A and FIG. 6B, the change in the potential at the node FD is one third of that in the case of FIG. 6A and FIG. 6B. By turning on the capacitance addition transistors M5 and M6 to increase the capacitance value of the floating diffusion and reducing the voltage amplitude at the node FD, all the signal charge accumulated in the photoelectric conversion element PD may be transferred to the node FD even when the voltage level of the voltage SVDD is lowered.

FIG. 8A and FIG. 8B illustrate the potentials in a state where the voltage level of the voltage SVDD is further lowered as compared with the case of FIG. 7A and FIG. 7B and the capacitance addition transistors M5 and M6 are both turned on to increase the capacitance value of the floating diffusion in the pixel of the second embodiment. The signs and the directions of the potentials described in the drawings are the same as those in FIG. 6A and FIG. 6B.

FIG. 8A illustrates the potential at the time of accumulating the signal charge in the photoelectric conversion element PD. In the exposure period of the photoelectric conversion element PD, the transfer transistor MI is turned off, and the signal charge is accumulated in the photoelectric conversion element PD. The capacitance addition transistors M5 and M6 are both turned on, and the capacitance value of the floating diffusion is (Cfd+Cinc1+Cinc2). Further, the signal level of the voltage SVDD is further lowered than that in the case of FIG. 7A and FIG. 7B, and the potential of the node FD is also lower than that in the case of FIG. 7A and FIG. 7B.

FIG. 8B illustrates the potential after transferring the signal charge from the photoelectric conversion element PD to the node FD. When the transfer transistor M1 is turned on, the potential barrier between the photoelectric conversion element PD and the node FD decreases to a position indicated by a broken line. As a result, a part of the signal charge accumulated in the photoelectric conversion element PD is transferred to the node FD. However, since the voltage level of the voltage SVDD is too low, all the charge accumulated in the photoelectric conversion element PD cannot be transferred to the node FD even though the capacitance value of the floating diffusion is three times that in the case of FIG. 6A and FIG. 6B, and the signal charge remains in the photoelectric conversion element PD.

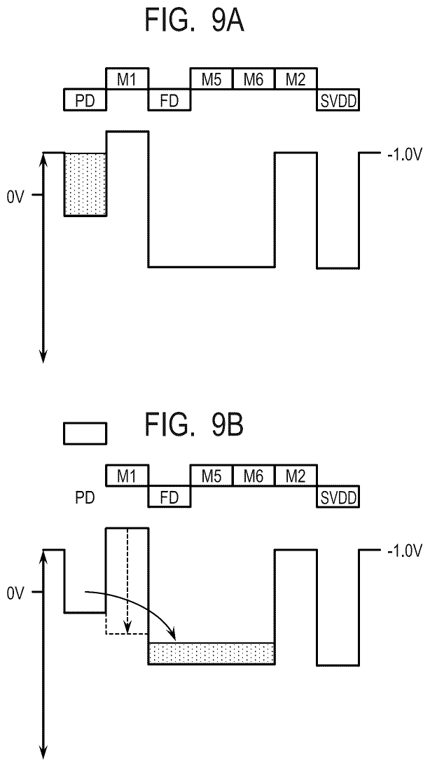

Next, a method of driving the photoelectric conversion device according to the present embodiment will be described with reference to FIG. 9A and FIG. 9B. FIG. 9A and FIG. 9B illustrate the potentials when the voltage level of the p-well in which the pixel 12 is disposed is changed from the ground voltage to the negative voltage in the states of FIG. 8A and FIG. 8B. The signs and the directions of the potentials described in the drawings are the same as those in FIG. 6A and FIG. 6B.

FIG. 9A illustrates a potential at the time of accumulating the signal charge in the photoelectric conversion element PD. In the exposure period of the photoelectric conversion element PD, the transfer transistor M1 is turned off, and the signal charge is accumulated in the photoelectric conversion element PD. The capacitance addition transistors M5 and M6 are both turned on, and the capacitance value of the floating diffusion is (Cfd+Cinc1+Cinc2).

Since the voltage SVDD is applied to the drain of the reset transistor M2, the voltage level of the drain of the reset transistor M2 is not different from that in the case of FIG. 8A and FIG. 8B even when the negative voltage is applied to the p-well in which the pixel 12 is disposed. Further, since the node FD is reset to a potential corresponding to the voltage SVDD via the reset transistor M2, the voltage level of the node FD is also the same as in the case of FIG. 8A and FIG. 8B.

On the other hand, in the photoelectric conversion element PD, since the capacitive coupling with the p-well is dominant, the potential of the photoelectric conversion element PD is shifted to the negative side by the amount of the negative voltage applied to the p-well. Further, since the channel region of the transfer transistor M1 is strongly capacitively coupled to the gate of the transfer transistor M1, the low-level for turning off the transfer transistor M1 is shifted to the negative side with respect to the ground voltage by the amount of the negative voltage applied to the p-well. Similarly to the transfer transistor M1, the low-level for turning off the reset transistor M2 in the reset transistor M2 is shifted to the negative side with respect to the ground voltage by the amount of the negative voltage applied to the p-well.

For example, when the low-level for turning off the transfer transistor M1 is originally set to −1 V and the voltage to be applied to the p-well in which the pixel 12 is disposed is lowered from 0 V to −1 V, the low-level for turning off the transfer transistor M1 is also lowered by 1 V and set to −2 V. When the low-level for turning off the reset transistor M2 is originally 0.5 V, the low-level for turning off the reset transistor M2 is also lowered by 1 V and set to −0.5 V as in the case of the transfer transistor M1.

FIG. 9B illustrates the potential after transferring the signal charge from the photoelectric conversion element PD to the node FD. When the transfer transistor M1 is turned on, the potential barrier between the photoelectric conversion element PD and the node FD decreases to a position indicated by a broken line. By applying a negative voltage to the p-well in which the pixel 12 is disposed, the potential of the photoelectric conversion element PD becomes relatively higher than the potential of the node FD, and all the signal charge held in the photoelectric conversion element PD may be transferred to the node FD. Further, the voltage level of the voltage SVDD may be further lowered to further reduce power consumption.

As described above, by applying the negative voltage to the p-well in which the pixel 12 is disposed, it is possible to suppress the transfer residue of the signal charge in the photoelectric conversion element PD which may occur with the decrease in the voltage SVDD. Accordingly, the voltage level of the voltage SVDD may be further lowered, and the power consumption may be further reduced.

In addition, in the present embodiment, the relationship of the potentials has been described on the assumption that each transistor constituting the pixel 12 is an n-channel transistor, but in the case where each transistor constituting the pixel 12 is a p-channel transistor, the relationship of the potentials is opposite to that described above. In the case of a p-channel transistor, when the absolute value of the voltage SVDD is lowered to reduce power consumption, it can be said that a voltage having a polarity opposite to that of the voltage SVDD is applied to the well in which the pixel is disposed.

As described above, according to the present embodiment, it is possible to realize the photoelectric conversion device capable of easily expanding the dynamic range according to the operation voltage of the pixel and improving the S/N ratio.

### Fourth Embodiment

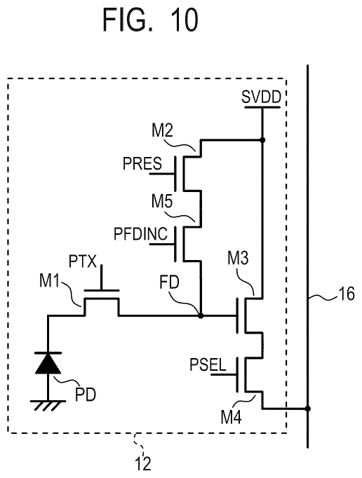

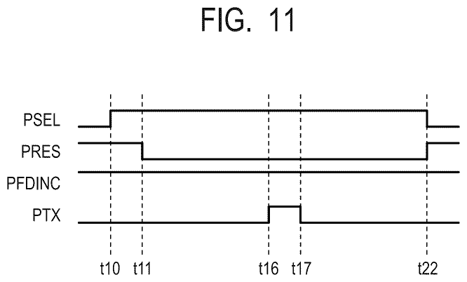

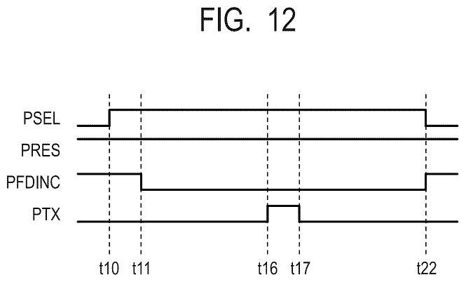

A photoelectric conversion device and a method of driving the same according to a fourth embodiment of the present invention will be described with reference to FIG. 10 to FIG. 12. The same components as those of the photoelectric conversion devices according to the first to third embodiments are denoted by the same reference numerals, and description thereof will be omitted or simplified. FIG. 10 is an equivalent circuit diagram illustrating a configuration example of a pixel in the photoelectric conversion device according to the present embodiment. FIG. 11 and FIG. 12 are timing charts illustrating a method of driving the photoelectric conversion device according to the present embodiment.

The photoelectric conversion device according to the present embodiment is the same as the photoelectric conversion device according to the first to third embodiments except that the configuration of the pixel 12 is different. In the present embodiment, differences from the photoelectric conversion devices according to the first to third embodiments will be mainly described, and description of points similar to those of the photoelectric conversion devices according to the first to third embodiments will be appropriately omitted.

As illustrated in FIG. 10, the pixel 12 of the photoelectric conversion device according to the present embodiment is different from the pixel according to the first embodiment in the connection location of the capacitance addition transistor M5. That is, while the capacitance addition transistor M5 is connected between the node FD and the floating node in the first embodiment, the capacitance addition transistor M5 is connected between the source of the reset transistor M2 and the node FD in the present embodiment. That is, the source of the capacitance addition transistor M5 is connected to the node FD, and the drain of the capacitance addition transistor M5 is connected to the source of the reset transistor M2. The control signal PFDINC is input to the gate of the capacitance addition transistor M5 from the vertical scanning circuit 20 via the control line 14.

Next, a method of driving the photoelectric conversion device according to the present embodiment will be described with reference to FIG. 11 and FIG. 12. FIG. 11 is a timing chart in the power saving mode, and FIG. 12 is a timing chart in the normal mode. In FIG. 11 and FIG. 12, timings at which operations similar to those in the timing chart of FIG. 4 are performed are denoted by the same times as in FIG. 4.

As illustrated in FIG. 11, the operation in the power saving mode, i.e., when the pixel signal is read out in a state where the channel capacitance of the capacitance addition transistor M5 is added to the node FD, is basically the same as the operation of the first embodiment described in FIG. 4. That is, the control signal PFDINC is fixed to high-level, and the reset operation of the node FD is performed by driving the reset transistor M2 by the control signal PRES. Other operations are the same as those in the power saving mode described in the first embodiment.

When the control signal PFDINC is set to high-level, the capacitance addition transistor M5 is turned on, and the capacitance value Cinc1 is added to the capacitance value Cfd of the node FD as in the case of the first embodiment. If it is assumed that the capacitance value Cfd of the floating diffusion when the capacitance addition transistor M5 is turned off and the capacitance value Cinc1 of the capacitance generated when the capacitance addition transistor M5 is turned on are the same, the capacitance value of the floating diffusion is doubled. Thus, the signal amplitude on the node FD and the vertical output line 16 may be reduced to one half. Therefore, as in the case of the first embodiment, the power consumption may be reduced by lowering the voltage level of the voltage SVDD.

When the pixel signal is read out in the normal mode, that is, in a state where the channel capacitance of the capacitance addition transistor M5 is not added to the node FD, as illustrated in FIG. 12, the control signal PRES is fixed to high-level, and the reset operation of the node FD is controlled by the control signal PFDINC. When both the reset transistor M2 and the capacitance addition transistor M5 are turned on in the period from time t10 to time t11, the node FD is reset to a potential corresponding to the voltage SVDD. At the time t11, the control signal PFDINC becomes low-level and the capacitance addition transistor M5 is turned off, whereby the reset state of the node FD is canceled.

In the case of the pixel configuration of the first embodiment, even when the reset transistor M2 and the capacitance addition transistor M5 are turned off at the time of reading out the pixel signal, the gate-source capacitances of these MOS transistors are added to the node FD. On the other hand, in the case of the pixel configuration of the present embodiment, the capacitance added to the node FD is only the gate-source capacitance of the capacitance addition transistor M5. Therefore, according to the present embodiment, it is possible to reduce the capacitance value of the floating diffusion when the capacitance addition transistor M5 is off. As a result, when the capacitance addition transistor M5 is off, the charge-voltage conversion coefficient at the node FD may be increased, and a signal with a high S/N ratio may be read out.

As described above, according to the present embodiment, it is possible to realize the photoelectric conversion device capable of easily expanding the dynamic range according to the operation voltage of the pixel and improving the S/N ratio.

### Fifth Embodiment

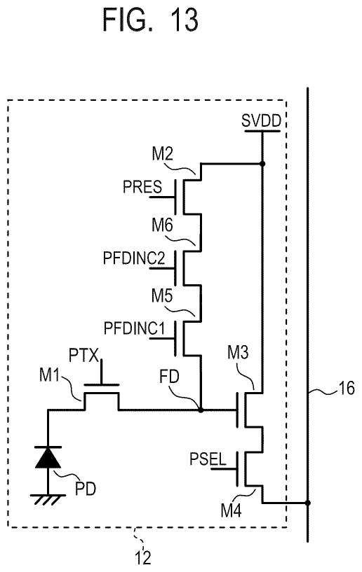

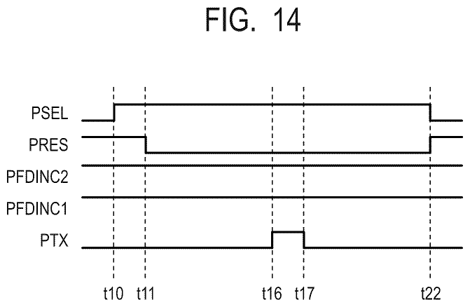

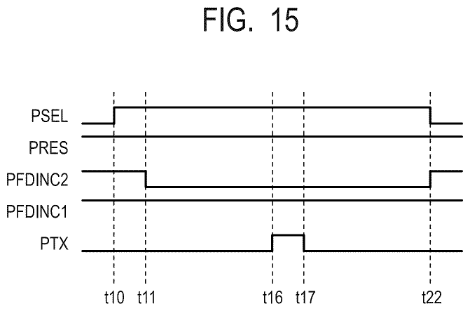

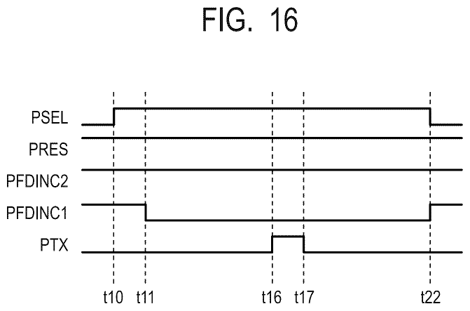

A photoelectric conversion device and a method of driving the same according to a fifth embodiment of the present invention will be described with reference to FIG. 13 to FIG. 16. The same components as those of the photoelectric conversion devices according to the first to fourth embodiments are denoted by the same reference numerals, and description thereof will be omitted or simplified. FIG. 13 is an equivalent circuit diagram illustrating a configuration example of a pixel in the photoelectric conversion device according to the present embodiment. FIG. 14 to FIG. 16 are timing charts illustrating a method of driving the photoelectric conversion device according to the present embodiment.

The photoelectric conversion device according to the present embodiment is the same as the photoelectric conversion device according to the first to fourth embodiments except that the configuration of the pixel 12 is different. In the present embodiment, differences from the photoelectric conversion devices according to the first to fourth embodiments will be mainly described, and description of points similar to those of the photoelectric conversion devices according to the first to fourth embodiments will be appropriately omitted.

As illustrated in FIG. 13, in the pixel 12 of the photoelectric conversion device according to the present embodiment, a capacitance addition transistor M6 is further added to the pixel 12 of the photoelectric conversion device according to the fourth embodiment. The capacitance addition transistor M6 is connected in series between the reset transistor M2 and the capacitance addition transistor M5. That is, a source of the capacitance addition transistor M6 is connected to the drain of the capacitance addition transistor M5, and a drain of the capacitance addition transistor M6 is connected to the source of the reset transistor M2. A control signal PFDINC1 is input to the gate of the capacitance addition transistor M5 from the vertical scanning circuit 20 via the control line 14, and a control signal PFDINC2 is input to a gate of the capacitance addition transistor M6 from the vertical scanning circuit 20 via the control line 14.

Next, a method of driving the photoelectric conversion device according to the present embodiment will be described with reference to FIG. 14 to FIG. 16. FIG. 14 is a timing chart in a power saving mode 2, FIG. 15 is a timing chart in the power saving mode 1, and FIG. 16 is a timing chart in a normal mode. In FIG. 14 to FIG. 16, timings at which operations similar to those in the timing chart of FIG. 4 are performed are denoted by the same times as those in FIG. 4.

In the power saving mode 2, that is, in the operation mode in which the capacitance value of the floating diffusion is maximized and the pixel signal is read out, as illustrated in FIG. 14, the control signals PFDINC1 and PFDINC2 are fixed to high-level. The reset operation of the node FD is performed by controlling the control signal PRES. Other operations are the same as those in the power saving mode described in the first embodiment.

By setting the control signals PFDINC1 and PFDINC2 to high-level to turn on the capacitance addition transistors M5 and M6, the channel capacitances of these transistors are added to the capacitance of the node FD. If it is assumed that the capacitance value Cfd of the floating diffusion when the capacitance addition transistor M5 is off is the same as each of the capacitance values Cinc1 and Cinc2 of the capacitances generated when the capacitance addition transistors M5 and M6 are on, the capacitance value of the floating diffusion becomes three times. As a result, the signal amplitude on the node FD and the vertical output line 16 may be reduced to one third. Therefore, as in the case of the second embodiment, it is possible to reduce the power consumption by lowering the voltage level of the voltage SVDD.

In the power saving mode 1, that is, in the operation mode in which only the capacitance addition transistor M5 is turned on to read out the pixel signal, as illustrated in FIG. 15, the control signals PRES and PFDINC1 are fixed to high-level. The reset operation of the node FD is performed by controlling the control signal PFDINC2. Other operations are the same as those in the power saving mode described in the first embodiment.

By setting the control signal PFDINC1 to high-level to turn on the capacitance addition transistor M5, the channel capacitance of the capacitance addition transistor M5 is added to the capacitance of the node FD. At this time, by setting the control signal PFDINC2 to low-level, the capacitance added to the floating diffusion capacitance becomes only the channel capacitance of the capacitance addition transistor M5. If it is assumed that the capacitance value Cfd of the floating diffusion when the capacitance addition transistor M5 is turned off and the capacitance value Cinc1 of the capacitance generated when the capacitance addition transistor M5 is turned on are the same, the capacitance value of the floating diffusion is doubled. Thus, the signal amplitude on the node FD and the vertical output line 16 may be reduced to one half. Therefore, as in the case of the second embodiment, it is possible to reduce the power consumption by lowering the voltage level of the voltage SVDD.

In the normal mode, that is, in the operation mode in which the pixel signal is read out in a state in which the channel capacitances of the capacitance addition transistors M5 and M6 are not added to the node FD, as illustrated in FIG. 16, the control signals PRES and PFDINC2 are fixed to high-level. The reset operation of the node FD is controlled by the control signal PFDINC1. When the reset transistor M2 and the capacitance addition transistors M5 and M6 are turned on in the period from time t10 to time t11, the node FD is reset to a potential corresponding to the voltage SVDD. At the time t11, the control signal PFDINC1 becomes low-level and the capacitance addition transistor M5 is turned off, whereby the reset state of the node FD is canceled.

In the case of the pixel configuration of the second embodiment, even when the reset transistor M2 and the capacitance addition transistors M5 and M6 are turned off at the time of reading out the pixel signal, the gate-source capacitances of these MOS transistors are added to the node FD. On the other hand, in the case of the pixel configuration of the present embodiment, the capacitance added to the node FD is only the gate-source capacitance of the capacitance addition transistor M5. Therefore, according to the present embodiment, it is possible to reduce the capacitance value of the floating diffusion when the capacitance addition transistor M5 is off. As a result, when the capacitance addition transistor M5 is off, the charge-voltage conversion coefficient at the node FD may be increased, and a signal with a high S/N ratio may be read out.

Note that, also in the pixel configurations of the fourth and fifth embodiments, when the voltage SVDD is lowered for power saving, as in the case of the first and second embodiments, the signal charge held by the photoelectric conversion element PD may not be completely transferred to the node FD. In such a case, as described in the third embodiment, it is effective to apply a negative voltage to the p-well in which the pixel 12 is disposed. By applying the negative voltage to the p-well in which the pixel 12 is disposed, it is possible to read out all signal charge held by the photoelectric conversion element PD even when the voltage SVDD is lowered. Further, the voltage level of the voltage SVDD may be further lowered to further reduce power consumption.

As described above, according to the present embodiment, it is possible to realize the photoelectric conversion device capable of easily expanding the dynamic range according to the operation voltage of the pixel and improving the S/N ratio.

### Sixth Embodiment

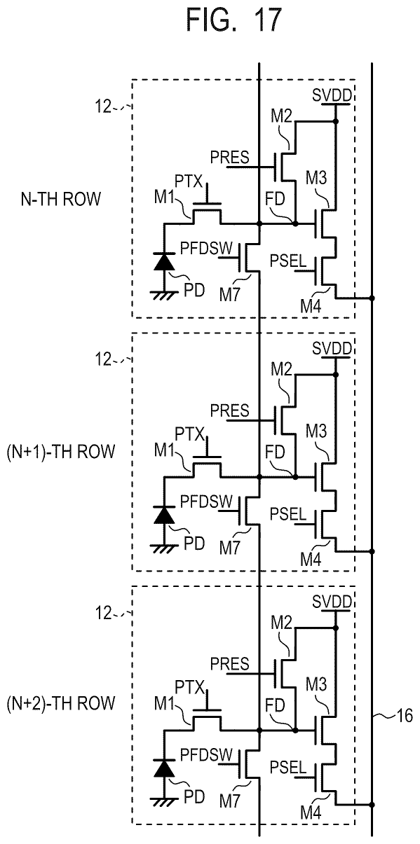

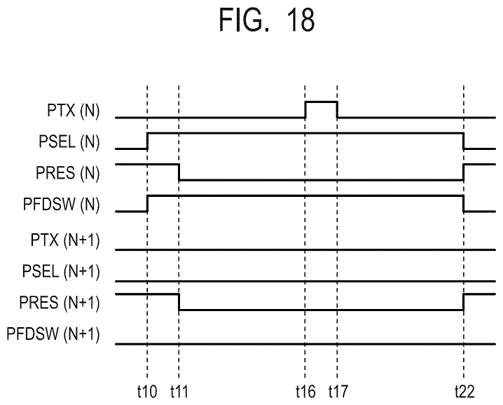

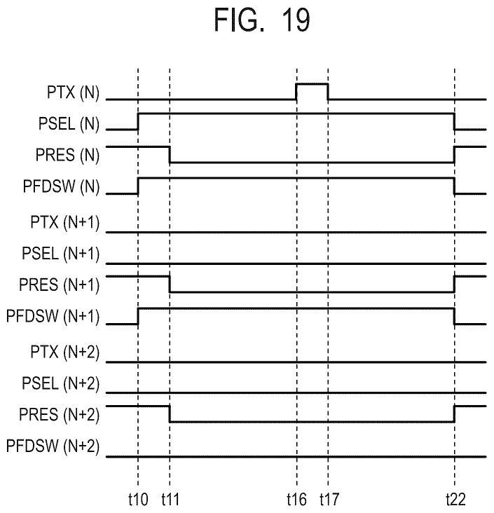

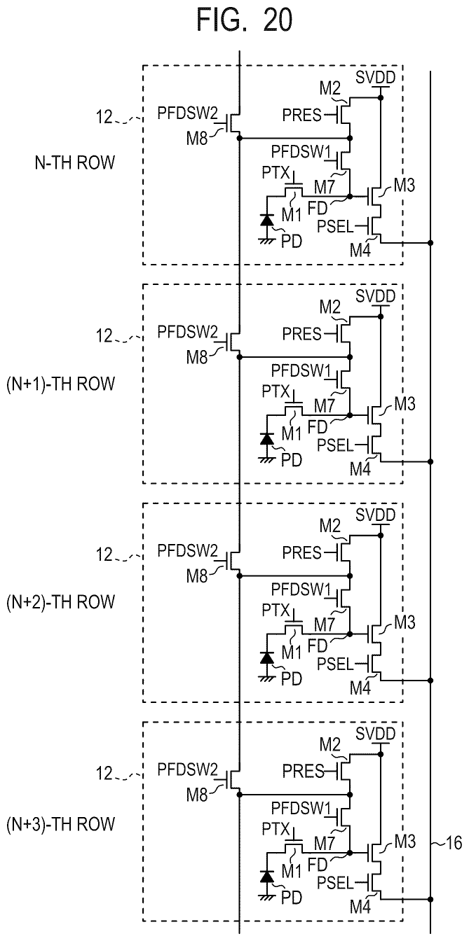

A photoelectric conversion device and a method of driving the same according to a sixth embodiment of the present invention will be described with reference to FIG. 17 to FIG. 19. The same components as those of the photoelectric conversion devices according to the first to fifth embodiments are denoted by the same reference numerals, and description thereof will be omitted or simplified. FIG. 17 is an equivalent circuit diagram illustrating a configuration example of a pixel in the photoelectric conversion device according to the present embodiment. FIG. 18 and FIG. 19 are timing charts illustrating a method of driving the photoelectric conversion device according to the present embodiment.

The photoelectric conversion device according to the present embodiment is the same as the photoelectric conversion device according to the first to fifth embodiments except that the configuration of the pixel 12 is different. In the present embodiment, differences from the photoelectric conversion devices according to the first to fifth embodiments will be mainly described, and description of points similar to those of the photoelectric conversion devices according to the first to fifth embodiments will be appropriately omitted

As illustrated in FIG. 17, the pixel 12 of the photoelectric conversion device according to the present embodiment further includes an FD connection transistor M7 instead of the capacitance addition transistors M5 and M6 in the pixel 12 of the photoelectric conversion device according to the first or second embodiment. The FD connection transistor M7 is connected between the nodes FD of the pixels 12 adjacent to each other in the column direction. For example, the pixel 12 in the N-th row includes the FD connection transistor M7 whose drain is connected to the node FD of the pixel 12 in the N-th row and whose source is connected to the node FD of the pixel 12 in the (N+1)-th row. The pixel 12 in the (N+1)-th row includes the FD connection transistor M7 whose drain is connected to the node FD of the pixel 12 in the (N+1)-th row and whose source is connected to the node FD of the pixel 12 in the (N+2)-th row. The pixel 12 in the (N+2)-th row includes the FD connection transistor M7 whose drain is connected to the node FD of the pixel 12 in the (N+2)-th row and whose source is connected to the node FD of the pixel 12 in the (N+3)-th row (not illustrated). The control signal PFDSW is input to the gate of the FD connection transistor M7 from the vertical scanning circuit 20 via the control line 14.

The FD connection transistor M7 is provided between the floating diffusion and the floating diffusion of another pixel and has a role as a switch circuit for controlling the connection therebetween. When the FD connection transistor M7 of each pixel 12 is off, the floating diffusion of each pixel 12 is independent of each other, and the capacitance value of the floating diffusion becomes minimum. Therefore, the charge-voltage conversion coefficient at the node FD becomes large, and the pixel signal may be read out with a high S/N ratio. Further, by setting the number of the FD connection transistors M7 in the on-state connected to the node FD of a certain pixel 12 to a desired number, the capacitance value of the floating diffusion of the pixel 12 may be set to a desired value according to the desired number.

Here, it is assumed that the capacitance value of the floating diffusion when there is no FD connection transistor M7 in the on-state connected to the node FD is Cfd, and the channel capacitance when the FD connection transistor M7 is on is Cfdsw. In this case, if there is one FD connection transistor M7 in the on-state connected to a certain node FD, two nodes FD are connected via the FD connection transistor M7, and the capacitance value of the entire floating diffusion is (2×Cfd+1×Cfdsw). Assuming that there are two FD connection transistors M7 in the on-state connected to a certain node FD, the three nodes FD are connected via the two FD connection transistors M7, and the capacitance value of the entire floating diffusion is (3×Cfd+2×Cfdsw). That is, as the number of the FD connection transistors M7 in the on-state connected to the node FD is increased, the capacitance value of the entire floating diffusion may be increased.

Next, a method of driving the photoelectric conversion device according to the present embodiment will be described with reference to FIG. 18 and FIG. 19. FIG. 18 is a timing chart in a case where the nodes FD of the two pixels 12 are connected to read out the pixel signal, and FIG. 19 is a timing chart in a case where the nodes FD of the three pixels 12 are connected to read out the pixel signal. In FIG. 18 and FIG. 19, timings at which operations similar to those in the timing chart of FIG. 4 are performed are denoted by the same times as in FIG. 4. In FIG. 18 and FIGS. 19, (N), (N+1), and (N+2) added to the reference numerals of the control signals PTX, PSEL, PRES, and PFDSW represent pixel rows to which these control signals are supplied.

In FIG. 18, it is assumed that the FD connection transistor M7 of the pixel 12 in the N-th row which is the selected row is turned on to connect the node FD of the pixel 12 in the N-th row to the node FD of the pixel 12 in the (N+1)-th row. The operations of outputting the pixel reset level signal after the reset of the node FD is canceled and outputting the pixel signal of the light signal level after the control signal PTX is driven by pulse are the same as those of the first embodiment described with reference to FIG. 4, and thus detailed description thereof is omitted here.

At time t10, the vertical scanning circuit 20 controls the control signal PFDSW(N) from low-level to high-level. As a result, the FD connection transistor M7 of the pixel 12 in the N-th row is turned on, and the node FD of the pixel 12 in the N-th row and the node FD of the pixel 12 in the (N+1)-th row are connected via the FD connection transistor M7 of the pixel 12 in the N-th row. As a result, the capacitance of the node FD of the pixel 12 in the N-th row, the capacitance of the node FD of the pixel 12 in the (N+1)-th row, and the channel capacitance of the FD connection transistor M7 of the pixel 12 in the N-th row are connected in parallel and constitute one capacitance (floating diffusion capacitance) as a whole.

At the subsequent time t11, the vertical scanning circuit 20 controls the control signals PRES(N) and PRES(N+1) from high-level to low-level and cancels the reset state of the floating diffusion capacitance. Accordingly, the floating diffusion capacitance including the capacitance of the node FD of the two pixels 12 and the channel capacitance of the FD connection transistor M7 is used as the charge-voltage conversion unit of the signal charge transferred from the photoelectric conversion element PD of the pixel of the N-th row, and the pixel signal may be read out.

In FIG. 19, it is assumed that the FD connection transistors M7 of the pixels 12 in the N-th row which is the selected row and the next (N+1)-th row are turned on to connect the nodes FD of the pixels 12 in the N-th row, the (N+1)-th row, and the (N+2)-th row. The operations of outputting the pixel reset level signal after the reset of the node FD is canceled and outputting the pixel signal of the light signal level after the control signal PTX is driven by pulse are the same as those of the first embodiment described with reference to FIG. 4, and thus detailed description thereof is omitted here.

At time t10, the vertical scanning circuit 20 controls the control signals PFDSW(N) and PFDSW(N+1) from low-level to high-level. As a result, the FD connection transistor M7 of the pixel 12 in the N-th row is turned on, and the node FD of the pixel 12 in the N-th row and the node FD of the pixel 12 in the (N+1)-th row are connected via the FD connection transistor M7 of the pixel 12 in the N-th row. Further, the FD connection transistor M7 of the pixel 12 in the (N+1)-th row is turned on, and the node FD of the pixel 12 in the (N+1)-th row and the node FD of the pixel 12 in the (N+2)-th row are connected via the FD connection transistor M7 of the pixel 12 in the (N+1)-th row. As a result, the capacitance of the node FD of each of the pixels 12 in the N-th row, the (N+1)-th row, and the (N+2)-th row and the channel capacitance of the FD connection transistor M7 of each of the pixels 12 in the N-th row and the (N+1)-th row are connected in parallel, and constitute one capacitance (floating diffusion capacitance) as a whole.

At the subsequent time t11, the vertical scanning circuit 20 controls the control signals PRES(N), PRES(N+1), and PRES(N+2) from high-level to low-level and cancels the reset state of the floating diffusion capacitance. Accordingly, the floating diffusion capacitance including the capacitance of the node FD of the three pixels 12 and the channel capacitances of the two FD connection transistors M7 is used as the charge-voltage conversion unit of the signal charge transferred from the photoelectric conversion element PD of the pixel of the N-th row, and the pixel signal may be read out.

As described above, in the present embodiment, the capacitance value of the floating diffusion may be adjusted by appropriately setting the number of the FD connection transistors M7 in the on-state connected to the node FD of the pixel 12 to be read out. By turning on the FD connection transistor M7 to increase the floating diffusion capacitance of the pixel 12 to be read out, the signal amplitude on the node FD and the vertical output line 16 may be narrowed to secure the dynamic range, and the voltage SVDD may be lowered. In addition, this makes it possible to perform appropriate driving while balancing image quality and power.

As described above, according to the present embodiment, it is possible to realize the photoelectric conversion device capable of easily expanding the dynamic range according to the operation voltage of the pixel and improving the S/N ratio.

### Seventh Embodiment

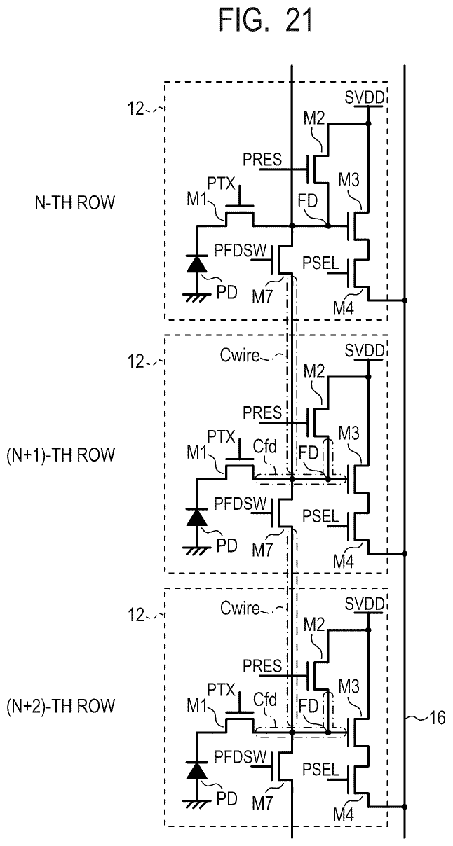

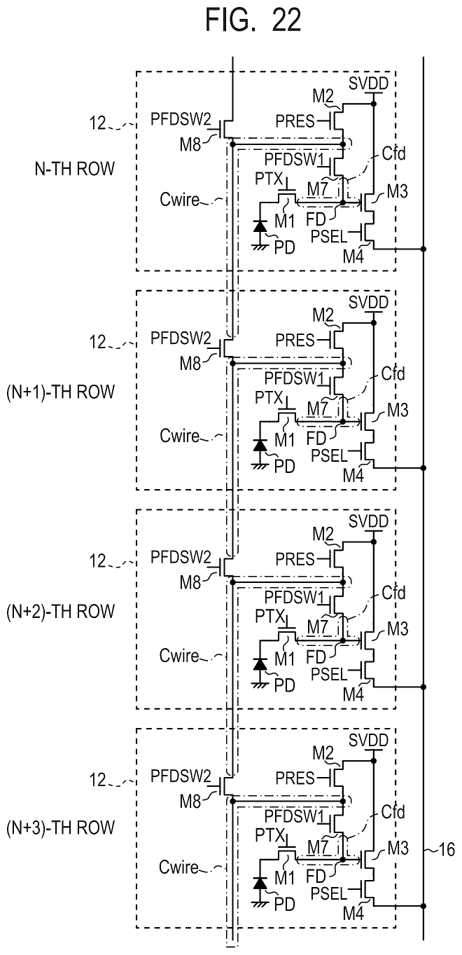

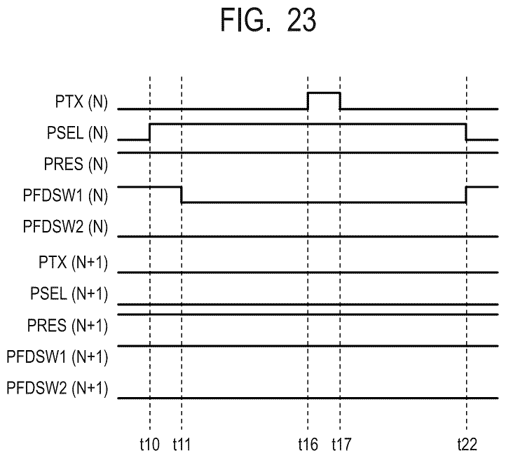

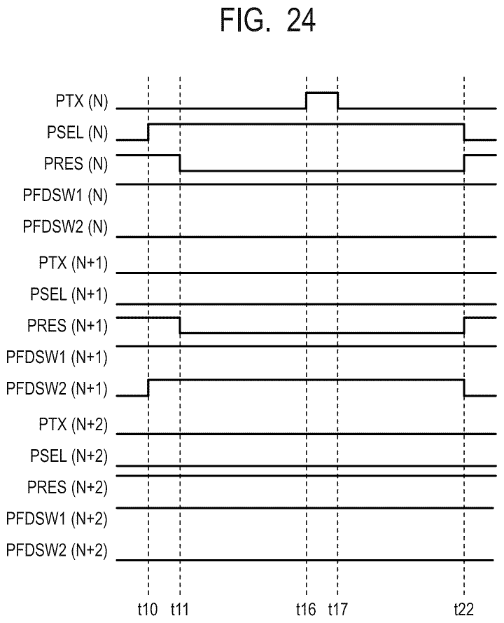

A photoelectric conversion device and a method of driving the same according to a seventh embodiment of the present invention will be described with reference to FIG. 20 to FIG. 25. The same components as those of the photoelectric conversion devices according to the first to sixth embodiments are denoted by the same reference numerals, and description thereof will be omitted or simplified. FIG. 20 is an equivalent circuit diagram illustrating a configuration example of a pixel in the photoelectric conversion device according to the present embodiment. FIG. 21 is a diagram illustrating an interconnection capacitance in the pixel configuration of the sixth embodiment. FIG. 22 is a diagram illustrating an interconnection capacitance in the pixel configuration of the present embodiment. FIG. 23 to FIG. 25 are timing charts illustrating a method of driving the photoelectric conversion device according to the present embodiment.

The photoelectric conversion device according to the present embodiment is the same as the photoelectric conversion device according to the first to sixth embodiments except that the configuration of the pixel 12 is different. In the present embodiment, differences from the photoelectric conversion devices according to the first to sixth embodiments will be mainly described, and description of points similar to those of the photoelectric conversion devices according to the first to sixth embodiments will be appropriately omitted.

As illustrated in FIG. 20, the pixel 12 of the photoelectric conversion device according to the present embodiment includes FD connection transistors M7 and M8 instead of the capacitance addition transistor M5 in the pixel 12 of the photoelectric conversion device according to the fourth embodiment. The FD connection transistor M7 is connected in series between the reset transistor M2 and the node FD. That is, a source of the FD connection transistor M7 is connected to the node FD. A drain of the FD connection transistor M7 is connected to the source of the reset transistor M2. The FD connection transistor M8 is connected between the connection nodes of the FD connection transistor M7 and the reset transistor M2 of the pixels 12 adjacent in the column direction. For example, a drain of the FD connection transistor M8 of the pixel 12 in the (N+1)-th row is connected to the connection node between the FD connection transistor M7 and the reset transistor M2 in the pixel 12 in the N-th row and a source of the FD connection transistor M8 of the pixel 12 in the N-th row. A drain of the FD connection transistor M8 of the pixel 12 in the row is connected to the connection node between the FD connection transistor M7 and the reset transistor M2 in the pixel 12 in the (N+1)-th row and a source of the FD connection transistor M8 in the pixel 12 in the (N+1)-th row. A drain of the FD connection transistor M8 of the pixel 12 in the (N+3)-th row is connected to the connection node between the FD connection transistor M7 and the reset transistor M2 in the pixel 12 in the (N+2)-th row and a source of the FD connection transistor M8 in the pixel 12 in the (N+2)-th row. A control signal PFDSW 1 is input to a gate of the FD connection transistor M7 from the vertical scanning circuit 20 via the control line 14, and a control signal PFDSW2 is input to a gate of the FD connection transistor M8 from the vertical scanning circuit 20 via the control line 14.

Focusing on the pixel 12 in the N-th row and the pixel 12 in the (N+1)-th row, the FD connection transistor M7, an interconnection, the FD connection transistor M7, and the FD connection transistor M7 are connected in series between the node FD of the pixel in the N-th row and the node FD of the pixel in the (N+1)-th row. These elements have a function as a switch circuit for controlling the connection between the floating diffusion of the pixel 12 in the N-th row and the floating diffusion of the pixel 12 in the (N+1)-th row. Each of the FD connection transistors M7 and M8 is a switch disposed between the floating diffusion of the pixel 12 in the N-th row and the floating diffusion of the pixel 12 in the (N+1)-th row.

In the pixel configuration of the sixth embodiment, as illustrated in FIG. 21, the node FD and the source of the FD connection transistor M7 of the adjacent pixel 12 are directly connected by an interconnection. Therefore, even when the FD connection transistor M7 is off, the wiring capacitance Cwire of the interconnection is added to the capacitance Cfd of the node FD, and the floating diffusion capacitance increases accordingly. As a result, depending on the size of the wiring capacitance Cwire, there is a possibility that the charge-voltage conversion coefficient at the time of turning off the FD connection transistor M7 cannot be sufficiently increased and a signal with a high S/N ratio cannot be obtained.

On the other hand, in the pixel configuration of the present embodiment, by turning off the FD connection transistor M7, the node FD may be separated from the interconnection connecting the pixels 12 adjacent in the column direction via the FD connection transistor M8. Accordingly, when the FD connection transistor M7 is turned off, as illustrated in FIG. 22, it is possible to prevent the wiring capacitance Cwire of the interconnection from being added to the capacitance Cfd of the node FD and to reduce the floating diffusion capacitance.

Next, a method of driving the photoelectric conversion device according to the present embodiment will be described with reference to FIG. 23 to FIG. 25. FIG. 23 is a timing chart in a case where the pixel signal is read out without connecting the nodes FD of two or more pixels 12. FIG. 24 is a timing chart in a case where the nodes FD of the two pixels 12 are connected to read out the pixel signal. FIG. 25 is a timing chart in a case where the nodes FD of the three pixels 12 are connected to read out the pixel signal. In FIG. 23 to FIG. 25, timings at which operations similar to those in the timing diagrams of FIG. 4 are performed are denoted by the same times as those in FIG. 4. In FIG. 23 to FIGS. 25, (N), (N+1), (N+2), and (N+3) added to the reference numerals of the control signals PTX, PSEL, PRES, PFDSW1, and PFDSW2 represent pixel rows to which these control signals are supplied. Here, it is assumed that the N-th row is the selected row and the pixel signal based on the signal charge accumulated in the photoelectric conversion element PD of the pixel 12 of the N-th row is output.

FIG. 23 illustrates an operation example corresponding to an operation mode in which the floating diffusion capacitance of the pixel 12 at the time of signal readout becomes minimum, that is, the above-described normal mode. The operations of outputting the pixel reset level signal after the reset of the node FD is canceled and outputting the pixel signal of the light signal level after the control signal PTX is driven by pulse are the same as those of the first embodiment described with reference to FIG. 4, and thus detailed description thereof is omitted here.

In this operation mode, as illustrated in FIG. 23, the control signal PRES is fixed to high-level, and the control signal PFDSW1 of the N-th row is driven to reset and cancel the reset of the node FD. When both the reset transistor M2 and the FD connection transistor M7 of the selected row are turned on in the period from time t10 to time t11, the node FD is reset to a potential corresponding to the voltage SVDD. At the time t11, the control signal PFDSW1 becomes low-level and the FD connection transistor M7 is turned off, whereby the reset state of the node FD is canceled.

At the time of reading out the pixel signal corresponding to the period from the time t11 to time t22, the control signal PFDSW1 is fixed to low-level, and the FD connection transistor M7 is turned off. Accordingly, since only the gate-source capacitance of the FD connection transistor M7 is applied to the node FD of the pixel 12 in the selected row, the capacitance value of the node FD at the time of reading out the pixel signal may be reduced.

FIG. 24 illustrates an operation example corresponding to an operation mode in which the nodes FD of the two pixels 12 are connected to read out the pixel signal, that is, the above-described power saving mode. The operations of outputting the pixel reset level signal after the reset of the node FD is canceled and outputting the pixel signal of the light signal level after the control signal PTX is driven by pulse are the same as those of the first embodiment described with reference to FIG. 4, and thus detailed description thereof is omitted here.

In the present operation mode, as illustrated in FIG. 24, the control signal PFDSW1 is fixed to high-level, and the control signal PRES of the N-th row and the (N+1)-th row is driven to reset and cancel the reset of the node FD of the pixel 12 of the N-th row and the (N+1)-th row. In a period from time t10 to time t11, the reset transistor M2 and the FD connection transistor M7 of the pixels 12 in the N-th row and the (N+1)-th row are both turned on, and thus the nodes FD is reset to a potential corresponding to the voltage SVDD. At the time t11, the control signal PRES becomes low-level and the reset transistor M2 is turned off, so that the reset state of the node FD is canceled. In the period from the time t10 to time t22, by fixing the control signal PFSW2 of the (N+1)-th row to high-level, the node FD of the N-th row and the node FD of the (N+1)-th row are connected to each other via the FD connection transistors M7 and M8.

At the time of reading out the pixel signal corresponding to the period from the time t11 to the time t22, in the N-th row, the control signals PRES and PFDSW2 are set to low-level, and the control signal PFDSW1 is set to high-level. Further, in the (N+1)-th row, the control signal PRES is set to low-level, and the control signals PFDSW1 and PFDSW2 are set to high-level. Further, in the (N+2)-th row, the control signals PRES and PFDSW1 are set to high-level, and the control signal PFDSW2 is set to low-level.

As a result, the node FD of the pixel 12 in the N-th row and the node FD of the pixel 12 in the (N+1)-th row are connected via the FD connection transistors M7 and M8 of the respective pixels 12. As a result, the total capacitance value of the floating diffusion capacitance connected to the node FD of the pixel 12 in the N-th row is (2×Cfd+2×Cwire+2×Cfdsw1+1×Cfdsw2). Here, Cfd is a capacitance value of the node FD when the FD connection transistor M7 is off, and Cwire is a wiring capacitance of an interconnection connecting the drain of the FD connection transistor M7 and the drain of the FD connection transistor M8. Further, Cfdsw1 is a channel capacitance of the FD connection transistor M7 in the on-state, and Cfdsw2 is a channel capacitance of the FD connection transistor M8 in the on-state.

FIG. 25 illustrates an operation example corresponding to an operation mode in which the nodes FD of the three pixels 12 are connected to read out the pixel signal, that is, the above-described power saving mode. The operations of outputting the pixel reset level signal after the reset of the node FD is canceled and outputting the pixel signal of the light signal level after the control signal PTX is driven by pulse are the same as those of the first embodiment described with reference to FIG. 4, and thus detailed description thereof is omitted here.

In the present operation mode, as illustrated in FIG. 25, the control signal PFDSW1 is fixed to high-level, and the control signals PRES of the N-th row, the (N+1)-th row, and the (N+2)-th row are driven to reset and cancel the reset of the nodes FD of the pixels 12 of the N-th row, the (N+1)-th row, and the (N+2)-th row. In the period from time t10 to time t11, both of the reset transistor M2 and the FD connection transistor M7 of the pixels 12 in the N-th row, the (N+1)-th row, and the (N+2)-th row are turned on, whereby the nodes FD of the pixels 12 in these rows are reset to a potential according to the voltage SVDD. At the time t11, the control signal PRES becomes low-level and the reset transistor M2 is turned off, so that the reset state of the node FD is canceled. In the period from the time t10 to time t22, by fixing the control signal PFSW2 of the (N+1)-th row and the (N+2)-th row to high-level, the nodes FD of the pixels 12 of the N-th row, the (N+1)-th row, and the (N+2)-th row are connected via the FD connection transistors M7 and M8.

At the time of reading out the pixel signal corresponding to the period from the time t11 to the time t22, in the N-th row, the control signals PRES and PFDSW2 are set to low-level, and the control signal PFDSW1 is set to high-level. In addition, in the (N+1)-th row and the (N+2)-th row, the control signals PRES are set to low-level, and the control signals PFDSW1 and PFDSW2 are set to high-level. Further, in the (N+3)-th row, the control signals PRES and PFDSW1 are set to high-level, and the control signal PFDSW2 is set to low-level.

As a result, the node FD of the pixel 12 in the N-th row, the node FD of the pixel 12 in the (N+1)-th row, and the node FD of the pixel 12 in the (N+2)-th row are connected via the FD connection transistors M7 and M8 of the pixels 12. As a result, the total capacitance value of the floating diffusion capacitance connected to the node FD of the pixel 12 in the N-th row is (3×Cfd+3×Cwire+3×Cfdsw1+2×Cfdsw2).

As described above, in the present embodiment, the capacitance value of the floating diffusion may be adjusted by appropriately setting the number of the FD connection transistors M7 and M8 in the on-state connected to the node FD of the pixel 12 to be read out. By turning on the FD connection transistors M7 and M8 to increase the floating diffusion capacitance of the pixel 12 to be read out, the signal amplitude on the node FD and the vertical output line 16 may be narrowed to secure the dynamic range, and the voltage SVDD may be lowered. Further, by turning off the FD connection transistor M7 of the pixel 12 to be read out, it is possible to prevent an unnecessary parasitic capacitance from being connected to the node FD. Accordingly, the floating diffusion capacitance of the pixel 12 to be read out may be reduced, and a signal having a good S/N ratio may be read out. In addition, by using them, it is possible to perform appropriate driving while balancing image quality and electric power.

As described above, according to the present embodiment, it is possible to realize the photoelectric conversion device capable of easily expanding the dynamic range according to the operation voltage of the pixel and improving the S/N ratio.

### Eighth Embodiment

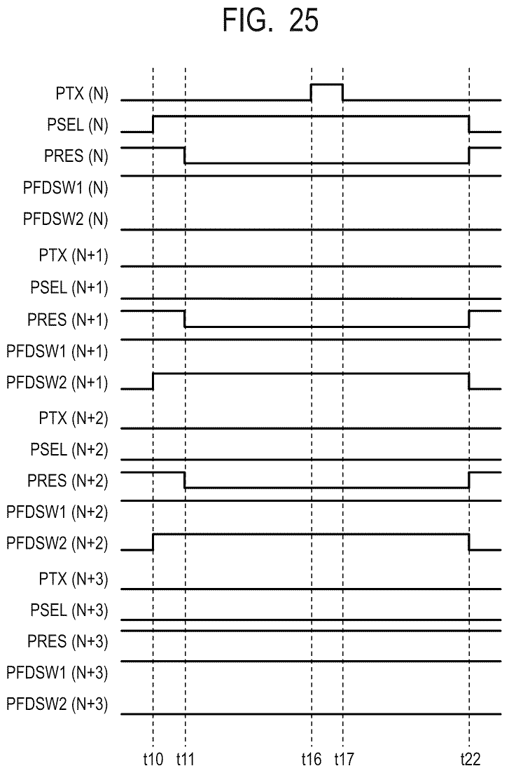

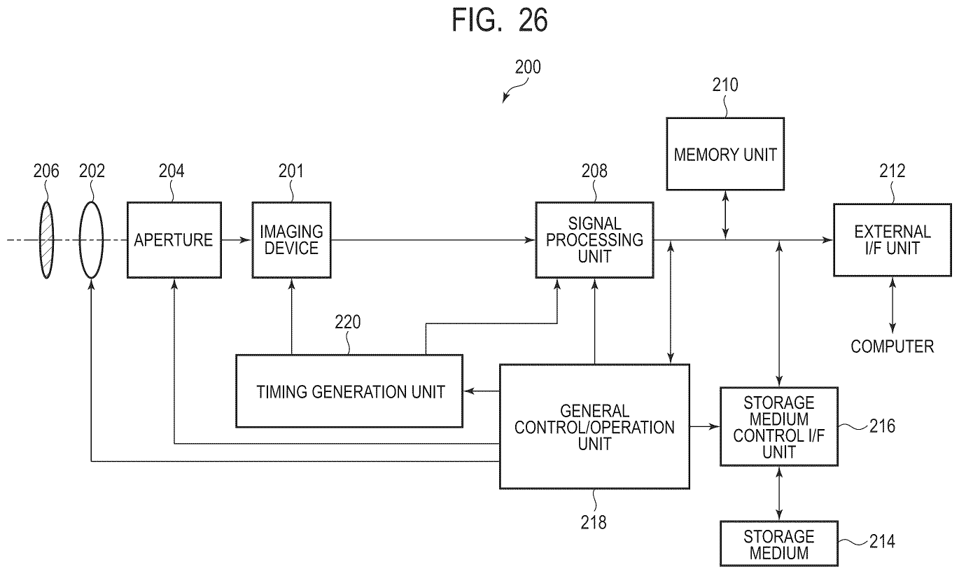

A photoelectric conversion system according to an eighth embodiment of the present invention will be described with reference to FIG. 26. FIG. 26 is a block diagram illustrating a schematic configuration of a photoelectric conversion system according to the present embodiment.

The photoelectric conversion device 100 described in the first to seventh embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 26 exemplifies a block diagram of a digital still camera as one of these.

The photoelectric conversion system 200 illustrated in FIG. 26 includes an imaging device 201, a lens 202 that forms an optical image of an object on the imaging device 201, an aperture 204 that changes an amount of light passing through the lens 202, and a barrier 206 that protects the lens 202. The lens 202 and the aperture 204 form an optical system that focuses light onto the imaging device 201. The imaging device 201 is the photoelectric conversion device 100 described in any of the first to seventh embodiments and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. The signal processing unit 208 may be formed on the same semiconductor substrate as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201, and outputs the processed image data. The signal processing unit 208 generates an image using the imaging signal.

As described above, according to the present embodiment, it is possible to realize a photoelectric conversion system to which the photoelectric conversion device 100 according to any of the first to seventh embodiments is applied.

### Ninth Embodiment

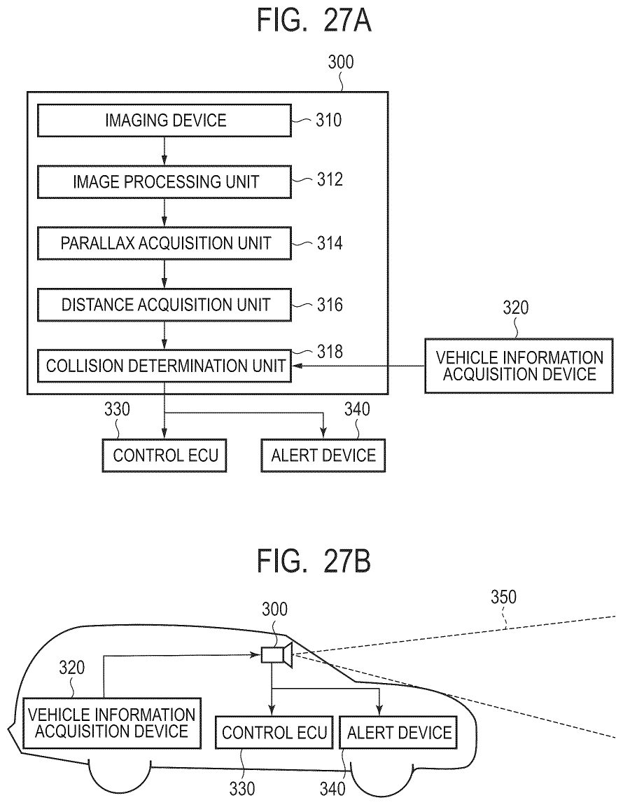

A photoelectric conversion system and a movable object according to a ninth embodiment of the present invention will be described with reference to FIG. 27A and FIG. 27B. FIG. 27A is a diagram illustrating a configuration of a photoelectric conversion system according to the present embodiment. FIG. 27B is a diagram illustrating a configuration of a movable object according to the present embodiment.

FIG. 27A illustrates an example of a photoelectric conversion system related to an on-vehicle camera. The photoelectric conversion system 300 includes an imaging device 310. The imaging device 310 is the photoelectric conversion device 100 according to any one of the first to seventh embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by field programmable gate array (FPGA), application specific integrated circuit (ASIC), or the like, or may be realized by a combination of these.

The photoelectric conversion system 300 is connected to the vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 27B illustrates the photoelectric conversion system in the case of capturing an image in front of the vehicle (imaging range 350). The vehicle information acquisition device 320 sends an instruction to the photoelectric conversion system 300 or the imaging device 310. With such a configuration, the accuracy of distance measurement may be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable object (mobile device) of a ship, an aircraft, or an industrial robot. In addition, the present invention is not limited to the movable object, and may be widely applied to an equipment using object recognition, such as ITS (Intelligent Transport Systems).

### Tenth Embodiment

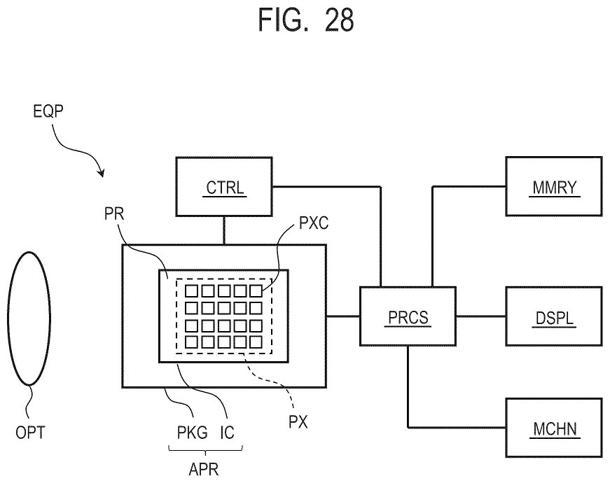

An equipment according to a tenth embodiment of the present invention will be described with reference to FIG. 28. FIG. 28 is a block diagram illustrating a schematic configuration of an equipment according to the present embodiment.

FIG. 28 is a schematic diagram illustrating an equipment EQP including a photoelectric conversion device APR. The photoelectric conversion device APR has the function of the photoelectric conversion device 100 according to any of the first to seventh embodiments. All or part of the photoelectric conversion device APR is a semiconductor device IC. The photoelectric conversion device APR of the present example may be used as, for example, an image sensor, an autofocus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be disposed in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be column circuits corresponding to pixel columns of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip interconnection by direct bonding of a conductor such as copper, a connection by a micro bump between chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an application specific integrated circuit (ASIC). The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further include a storage device MMRY and a processing device PRCS separately from the storage circuit unit and the arithmetic circuit unit included in the photoelectric conversion device APR.

The equipment EQP illustrated in FIG. 28 may be an electronic device such as an information terminal (for example, a smartphone or a wearable terminal) having a photographing function or a camera (for example, an interchangeable lens camera, a compact camera, a video camera, and a monitoring camera. The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present invention is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present invention.

Although the capacitance values Cfd, Cinc1, and Cinc2 are the same in the first to seventh embodiments, the capacitance values Cfd, Cinc1, and Cinc2 are not necessarily the same, and may be appropriately set according to the degree of power saving, the number of power saving modes, and the like.

In the second embodiment, the two capacitance addition transistors M5 and M6 are connected in parallel to the node FD, and in the fifth embodiment, the two capacitance addition transistors M5 and M6 are connected in series between the node FD and the reset transistor M2. However, the number of capacitance addition transistors connected to the node FD may be three or more.

Further, in the sixth embodiment, a driving example in which the nodes FD of the pixels 12 adjacent to each other in the column direction are connected to each other to increase the floating diffusion capacitance of the pixel to be read out is described, but only the wiring capacitance Cwire may be added to the capacitance Cfd. In this case, the FD connection transistors M7 of the pixels 12 in the selected row may be set to on-state, the FD connection transistors M7 of the pixels 12 in the other rows may be set to off-state, and the number of the FD connection transistors M8 to be turned on may be appropriately set according to the capacitance value required for the floating diffusion capacitance.

In the sixth and seventh embodiments, a driving example in which the nodes FD of the pixels 12 adjacent to each other in the column direction are connected to increase the floating diffusion capacitance of the pixel to be read out is described, but the nodes FD of the pixels 12 adjacent to each other in the row direction may be connected to each other. Alternatively, the nodes FD of the pixels 12 adjacent to each other in the column direction and the pixels 12 adjacent to each other in the row direction may be connected to each other.

Further, in the sixth and seventh embodiments, a driving example in which the signal charge held by the photoelectric conversion element PD of one pixel 12 is read out is described, but a configuration may be adopted in which the signal charges held by the photoelectric conversion elements PD of a plurality of pixels 12 are added and read out on the node FD. For example, in the driving example of FIG. 24, the control signal PTX of the (N+1)-th row may be driven at the same timing as the control signal PTX of the N-th row. Accordingly, the signal charge held in the photoelectric conversion element PD of the pixel 12 in the N-th row and the signal charge held in the photoelectric conversion element PD of the pixel 12 in the (N+1)-th row may be simultaneously read out to the node FD of the pixel 12 in the N-th row. In such a case, since the signal amplitude on the node FD becomes large, it is desirable to read out the signal by increasing the voltage SVDD from the viewpoint of securing the dynamic range.

In addition, capacitance addition transistors M5 and M6 similar to those of the first or second embodiment may be further added to the pixel configuration of the sixth or seventh embodiment. In this case, both the capacitance adjustment by the connection between the nodes FD and the capacitance adjustment by the capacitance addition transistors M5 and M6 are possible, and the floating diffusion capacitance may be adjusted more finely. Further, by lowering the voltage SVDD in accordance with the floating diffusion capacitance, power consumption may be reduced.

Further, also in the pixel configuration of the sixth or seventh embodiment, as in the case of the pixel configuration of the first or second embodiment, too low a voltage SVDD for power saving may fail to transfer the signal charge from the photoelectric conversion element PD to the node FD. In such a case, as described in the third embodiment, by applying a negative voltage to the p-well in which the pixel 12 is disposed, it is possible to read out all the signal charge of the photoelectric conversion element PD while lowering the voltage SVDD. This makes it possible to further reduce power consumption.

The photoelectric conversion systems described in the eighth and ninth embodiments are examples of photoelectric conversion systems to which the photoelectric conversion device of the present invention may be applied, and the photoelectric conversion system to which the photoelectric conversion device of the present invention can be applied is not limited to the configuration illustrated in FIG. 26 and FIG. 27A.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-182407, filed Oct. 24, 2023, which is hereby incorporated by reference herein in its entirety.

What is claimed is:

1. A photoelectric conversion device comprising:
a pixel including a photoelectric conversion unit configured to generate charge by photoelectric conversion, a floating diffusion configured to hold charge transferred from the photoelectric conversion unit, and an output unit configured to output a signal corresponding to an amount of charge held in the floating diffusion, the pixel being enabled to switch a capacitance value of the floating diffusion; and
a control unit configured to switch the capacitance value of the floating diffusion,
wherein the control unit is configured to set the floating diffusion to a first capacitance value when an absolute value of a power supply voltage supplied to the output unit is a first voltage and set the floating diffusion to a second capacitance value larger than the first capacitance value when the absolute value of the power supply voltage is a second voltage lower than the first voltage.

2. The photoelectric conversion device according to claim 1,
wherein the pixel further includes a transistor connected to the floating diffusion, and
wherein the control unit is configured to set the floating diffusion to the first capacitance value by controlling the transistor to be off and set the floating diffusion to the second capacitance value by controlling the transistor to be on.

3. The photoelectric conversion device according to claim 2, wherein the transistor is connected between the floating diffusion and a floating node.

4. The photoelectric conversion device according to claim 3, wherein the transistor comprises a plurality of transistors connected in parallel between the floating diffusion and the floating node.

5. The photoelectric conversion device according to claim 2 further comprising:
a reset unit configured to reset the floating diffusion to a potential according to the power supply voltage, and
wherein the transistor is connected between the reset unit and the floating diffusion.

6. The photoelectric conversion device according to claim 5, wherein the transistor comprises a plurality of transistors serially connected between the reset unit and the floating diffusion.

7. The photoelectric conversion device according to claim 4, wherein the control unit is configured to set the capacitance value of the floating diffusion by controlling the number of transistors controlled to be on among the plurality of transistors.

8. The photoelectric conversion device according to claim 7, wherein the control unit is configured to set the floating diffusion to a third capacitance value larger than the second capacitance value when the absolute value of the power supply voltage is a third voltage lower than the second voltage.

9. The photoelectric conversion device according to claim 1,
wherein the pixel comprises a plurality of pixels,
wherein each of the plurality of pixels further includes a switch circuit provided between the floating diffusion of one pixel and the floating diffusion of another pixel, and
wherein the control unit is configured to set the capacitance value of the floating diffusion of the one pixel by controlling the switch circuit.

10. The photoelectric conversion device according to claim 9, wherein the control unit is configured to set the floating diffusion of the one pixel to the first capacitance value by turning off the switch circuit and disconnecting the floating diffusion of the another pixel from the floating diffusion of the one pixel, and set the floating diffusion of the one pixel to the second capacitance value by turning on the switch circuit and connecting the floating diffusion of the one pixel to the floating diffusion of the another pixel.

11. The photoelectric conversion device according to claim 9, wherein the control unit is configured to set the capacitance value of the floating diffusion of the one pixel by controlling the number of pixels, each of which the floating diffusion thereof is connected to the floating diffusion of the one pixel by the switch circuit.

12. The photoelectric conversion device according to claim 9,
wherein the switch circuit includes a first switch, an interconnection and a second switch provided between the floating diffusion of the one pixel and the floating diffusion of the another pixel in this order, and
wherein the control unit is configured to set the floating diffusion of the one pixel to the first capacitance value by turning off the first switch and the second switch and disconnecting the interconnection from the floating diffusion of the one pixel.

13. The photoelectric conversion device according to claim 9,
wherein the switch circuit includes a first switch, an interconnection and a second switch provided between the floating diffusion of the one pixel and the floating diffusion of the another pixel in this order, and
wherein the control unit is configured to set the floating diffusion of the one pixel to the second capacitance value by turning on the first switch and turning off the second switch to apply a parasitic capacitance of the interconnection to the floating diffusion of the one pixel.

14. The photoelectric conversion device according to claim 9, wherein the switch circuit is configured to connect the floating diffusion of the one pixel and the floating diffusion of the another pixel adjacent in a column direction.

15. The photoelectric conversion device according to claim 9, wherein the switch circuit is configured to connect the floating diffusion of the one pixel and the floating diffusion of the another pixel adjacent in a row direction.

16. The photoelectric conversion device according to claim 1, wherein when the power supply voltage is set to the second voltage, a voltage of an opposite polarity to the power supply voltage is applied to a well in which the pixel is disposed.

17. The photoelectric conversion device according to claim 16, wherein the voltage of the opposite polarity is set so that all the charge held in the photoelectric conversion unit is transferred to the floating diffusion when the charge is transferred from the photoelectric conversion unit to the floating diffusion.

18. A photoelectric conversion system comprising:
the photoelectric conversion device according to claim 1; and
a signal processing device configured to process a signal output from the photoelectric conversion device.

19. A movable object comprising:
the photoelectric conversion device according to claim 1; and
a distance information acquisition unit configured to acquire distance information to an object from a parallax image based on a signal from the photoelectric conversion device; and
a control unit configured to control the movable object based on the distance information.

20. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
